(19) United States
(12) Patent Application Publication
(10) Pub. No.: US 2025/0259362 A1
(43) Pub. Date: Aug. 14, 2025

(54) PROMPT EDITOR FOR USE WITH A VISUAL MEDIA GENERATIVE RESPONSE ENGINE

(71) Applicant: OpenAI OpCo, LLC., San Francisco, CA (US)

(72) Inventors: Timothy Brooks, San Francisco, CA (US); William Joseph Flynn, Brooklyn, NY (US); William Peebles, San Francisco, CA (US); Aditya Ramesh, San Francisco, CA (US); Rohan Sahai, San Francisco, CA (US); David Schnurr, San Francisco, CA (US); Rajeev Nayak, San Francisco, CA (US); Jotham Taylor, III, Berkeley, CA (US); Wesam Manassra, San Francisco, CA (US); Boyang Niu, San Francisco, CA (US); Michael Starr, San Francisco, CA (US); Gilman Tolle, San Francisco, CA (US)

(73) Assignee: OpenAI OpCo, LLC., San Francisco, CA (US)

(21) Appl. No.: 19/042,594

(22) Filed: Jan. 31, 2025

Related U.S. Application Data
(60) Provisional application No. 63/553,637, filed on Feb. 14, 2024.
(60) Provisional application No. 63/729,367, filed on Dec. 7, 2024.

(51) Int. Cl. G06T 13/00; G06F 40/166; G06F 40/284; G06T 3/40; G06T 11/00

(52) U.S. Cl. CPC G06T 13/00; G06F 40/166; G06T 3/40; G06T 11/00; G06F 40/284; G06T 2200/24

(57) ABSTRACT

The present technology pertains to a prompt editor for use with a visual media generative response engine, where a user inputs a text prompt describing visual media to be generated by the visual media generative response engine. Upon receiving a command to generate the visual media, the present technology determines at least one of the duration, resolution, or aspect ratio for the media prior to generation. The visual media generative response engine creates the visual media based on the input prompt and the specified and determined characteristics. The generated visual media is received having the specified attributes.

### CROSS-REFERENCE TO RELATED APPLICATIONS

This application claims the benefit of and priority to U.S. provisional application No. 63/553,637 filed on Feb. 14, 2024, and U.S. provisional application No. 63/729,367 filed on Dec. 7, 2024, both of which are expressly incorporated by reference herein in its entirety.

### BACKGROUND

The last several years have brought many exciting developments in the fields of machine learning and artificial intelligence (AI). Large language models built on a transformer architecture and image generation models built on diffusion models have significantly advanced capabilities of the quality of content that can be created by software. Not only have such tools provided efficiency gains by utilizing AI tools to perform process tasks, but AI tools have also been found to be useful in the creative process as well. Some artists use AI tools to help brainstorm or enhance ideas.

Recently, artists have started using AI tools to bring artistic visions to life by directing AI tools to create writings and images as directed by the artists and other creatives. Thus, we are entering an exciting new era in the development of new forms of media creation.

At the same time, AI tools are still at the early stage of development. There are many technical challenges that remain to be solved. One such problem is the limits on model attention that challenge the amount of memory available to processing units. This limitation has severely limited the capabilities of AI tools for video generation and long-form text generation.

Interfaces to AI tools are even more nascent. Until recently, most prompts for AI tools involved text input. Only recently have multi-modal (a combination of image, text, and/or audio) prompts become possible. Even with multi-modal prompts, prompts are still delivered, and the AI tool responds to the prompt. Prompts are often provided in a chat interface or via an application programming interface (API).

Accordingly, AI tools have shown a lot of promise and many anticipate AI tools having a large impact in the future. At the same time, there are still many technical and user interface limitations to be overcome before AI tools become more useful in the creation of high-quality videos and longer-form outputs of any modality.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example system architecture for a visual media generative response engine in accordance with some embodiments of the present technology.

FIG. 2 illustrates noisy frames that are input into a diffusion model in accordance with some embodiments of the present technology.

FIG. 3A and FIG. 3B illustrates examples of encoding noisy frames and prompt frames into a collection of spacetime patches in accordance with some embodiments of the present technology.

FIG. 4 illustrates the vector of latent representations in greater detail in accordance with some embodiments of the present technology.

FIG. 5 illustrates an example process for generating visual media of disparate durations, resolutions, and aspect ratios using a visual media generative response engine in accordance with some embodiments of the present technology.

FIG. 6 illustrates an example process illustrating additional functions of the input layer in accordance with some embodiments of the present technology.

FIG. 7 illustrates an example process for training a visual media generative response engine in accordance with some embodiments of the present technology.

FIG. 8 illustrates an example system supporting a generative response engine during inference operations in accordance with some embodiments of the present technology.

FIG. 9A, FIG. 9B, and FIG. 9C illustrates an example transformer architecture in accordance with some embodiments of the present technology.

FIG. 10 illustrates an example process for presenting and using a graphical user interface to create a prompt for generating visual media in accordance with some embodiments of the present technology.

FIG. 11 illustrates an example library interface in accordance with some embodiments of the present technology.

FIG. 12 illustrates a resolution input control menu in accordance with some embodiments of the present technology.

FIG. 13 illustrates an aspect ratio input control menu in accordance with some embodiments of the present technology.

FIG. 14A and FIG. 14B illustrates a style control menu and configuration interface in accordance with some embodiments of the present technology.

FIG. 15 illustrates a number of generations input control in accordance with some embodiments of the present technology.

FIG. 16 illustrates an example process for creating new visual media from existing visual media prompts in accordance with some embodiments of the present technology.

FIG. 17A illustrates an example frame from a previously created visual media in accordance with some embodiments of the present technology.

FIG. 17B illustrates editing options in accordance with some embodiments of the present technology.

FIG. 18 illustrates an example process for aiding a user in generating a prompt to a visual media generative response engine through a storyboard user interface in accordance with some embodiments of the present technology.

FIG. 19A, FIG. 19B, FIG. 19C, and FIG. 19D illustrates aspects of a storyboard user interface in accordance with some embodiments of the present technology.

FIG. 20A, FIG. 20B, and FIG. 20C illustrates an example of a generated video and a populated storyboard user interface corresponding to the generated video in accordance with some embodiments of the present technology.

FIG. 21 illustrates an example of using the storyboard user interface to transition a visual media into a different scene in accordance with some embodiments of the present technology.

FIG. 22A and FIG. 22B illustrates an example of enhancing a prompt to be more descriptive in accordance with some embodiments of the present technology.

FIG. 23 illustrates an example process for inducing a visual media generative response engine to refactor an existing visual media in accordance with some embodiments of the present technology.

FIG. 24A and FIG. 24B illustrates a remix strength control menu in accordance with some embodiments of the present technology.

FIG. 25 illustrates an example process for influencing a blending of a first visual media with a second visual media in accordance with some embodiments of the present technology.

FIG. 26A and FIG. 26B illustrates an example of blending interface in accordance with some embodiments of the present technology.

FIG. 27A, FIG. 27B, and FIG. 27C illustrate frames of a blended visual media using a transition blend curve in accordance with some embodiments of the present technology.

FIG. 28 illustrates a loop interface in accordance with some embodiments of the present technology.

FIG. 29 illustrates a trim frames interface button in accordance with some embodiments of the present technology.

FIG. 30 illustrates an example process for requesting visual media from a visual media generative response engine using an API in accordance with some embodiments of the present technology.

FIG. 31 illustrates an example of an API call in accordance with some embodiments of the present technology.

FIG. 32 illustrates an example process for moderating visual media generated by the visual media generative response engine in accordance with some embodiments of the present technology.

FIG. 33 is a block diagram illustrating an example machine-learning platform for implementing various aspects of this disclosure in accordance with some aspects of the present technology.

FIG. 34 shows an example of a system for implementing some embodiments of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Recently, artists have started using AI tools to bring artistic visions to life by directing AI tools to create writings and images as directed by the artists and other creatives. Thus, we are entering an exciting new era in the development of new forms of media creation.

At the same time, AI tools are still in the early stage of development. There are many technical challenges that remain to be solved. One such problem is the limits on model attention that challenge the amount of memory available to processing units. This limitation has severely limited the capabilities of AI tools for video generation and long-form text generation.

Interfaces to AI tools are even more nascent. Until recently, most prompts for AI tools involved text input. Only recently have multi-modal (a combination of image, text, and/or audio) prompts become possible. Even with multi-modal prompts, prompts are still delivered to the AI tool, and the AI tool responds to the prompt. Prompts are often provided in a chat interface or via an application programming interface (API).

Accordingly, AI tools have shown a lot of promise and many anticipate AI tools having a large impact in the future. At the same time, there are still many technical and user interface limitations to be overcome before AI tools become more useful in the creation of high-quality videos and longer-form outputs of any modality.

The present technology addresses these problems and more to result in a first-of-its-kind visual media generative response engine that can produce high-quality videos. The visual media generative response engine can also produce visual media in a variety of aspect ratios, resolutions, and lengths.

In order to build a visual media generative response engine that can produce such videos, many technical challenges were overcome. And some of the solutions to these technical challenges are applicable outside of visual media generation, too. Therefore, while the present description will be addressed in the context of a visual media generative response engine, it should be appreciated that many of the embodiments addressed herein are innovative techniques in themselves that can be utilized in generative response engines that might produce audio, text, or audio-visual generation or other multi-modal generation.

As introduced above, the present technology is the first-of-its-kind. Not only is the present technology the first to be able to produce high-quality video of a variety of lengths, resolutions, and aspect ratios, but the present technology is also the first to use a diffusion-transformer architecture. This architecture provides the benefits of diffusion models, which have shown good results in producing images, and transformer models, which have been relatively scalable models.

Another improvement provided by the present technology is that the visual media generative response engine of the present technology represents the physical world and objects within it with remarkable accuracy. This is an artifact of the sheer volume of video that the present technology has been trained upon, and the fact that the present technology was trained on native video. By native video, it means that the video has not been preprocessed. Most machine learning models require the input data to be uniform. Therefore, prior attempts at image and video models provided input in a uniform resolution, aspect ratio, and length of video. However, this can result in distortions in the visual media. Whether scaling or cropping frames, the images in frames can be distorted. Even truncating a video distorts the beginning and end of a concept depicted by the visual artist. Of course, the ability of the visual media generative response engine to learn on images and video of any resolution, aspect ratio, and length of video creates its own technical challenges. These challenges were addressed by breaking up frames of input photos and video into spacetime patches, where each patch is a uniform size, but any number of spacetime patches can be utilized to capture an entire frame.

Another innovation the present technology provides is its ability to receive and utilize both image and text prompts to guide video creation. For example, the present technology can enable novel use cases such as starting a generated video from an input image or video, ending a generated video from an input image or video, blending from one image or video to another image or video, and extracting a feature from an image or video by rendering frames including the feature. These use cases are enabled by passing some visual frames to the diffusion-transformer and passing some text prompts to the diffusion-transformer. Of course, the diffusion-transformer also needs to be trained using a mix of these input types, too. The visual input and text input can be passed into the diffusion-transformer at the position of certain frames, thereby instructing the model what visual input to maintain across generated frames and how the generated frames should relate to the visual input throughout the video progression. This innovation provides the benefit of making the visual media generative response engine more versatile and gives artists a better ability to convey their vision to the visual media generative response engine.

Another innovative aspect of the present technology is in the user interface provided to allow users to give inputs to the visual media generative response engine. The present technology includes several innovative graphical user interfaces. One such graphical user interface is a timeline interface where at some points in the timeline a visual prompt frame can be provided as an input, while at other points in the timeline text prompts can be provided. In this way, an artist can guide the visual media generative response engine to generate a video that fulfills the artist's vision more faithfully.

These and other innovations are addressed in more detail herein.

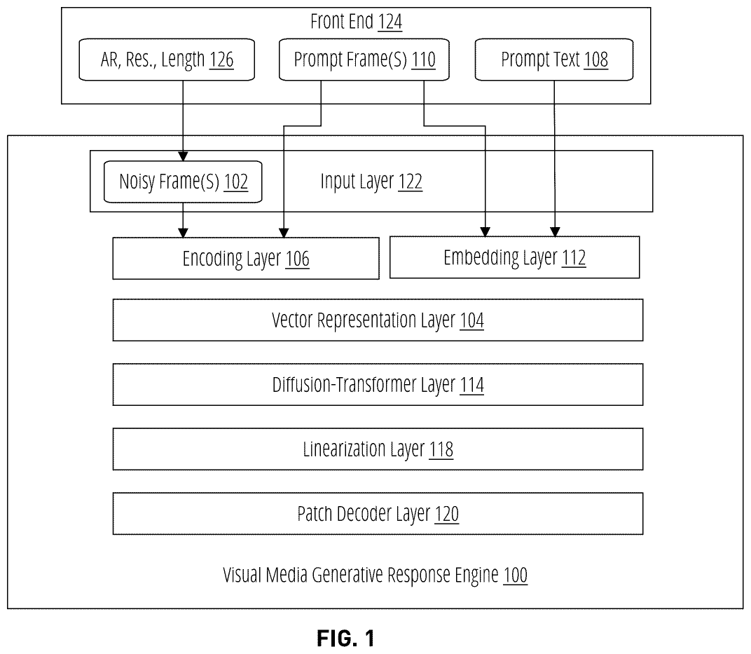

FIG. 1 illustrates an example system architecture for a visual media generative response engine 100 in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

FIG. 1 illustrates layers of visual media generative response engine 100 starting at front end 124, which receives user inputs, through diffusion-transformer layer 114, which generates the visual media, to an output of patch decoder layer 120 which outputs frames of the visual media.

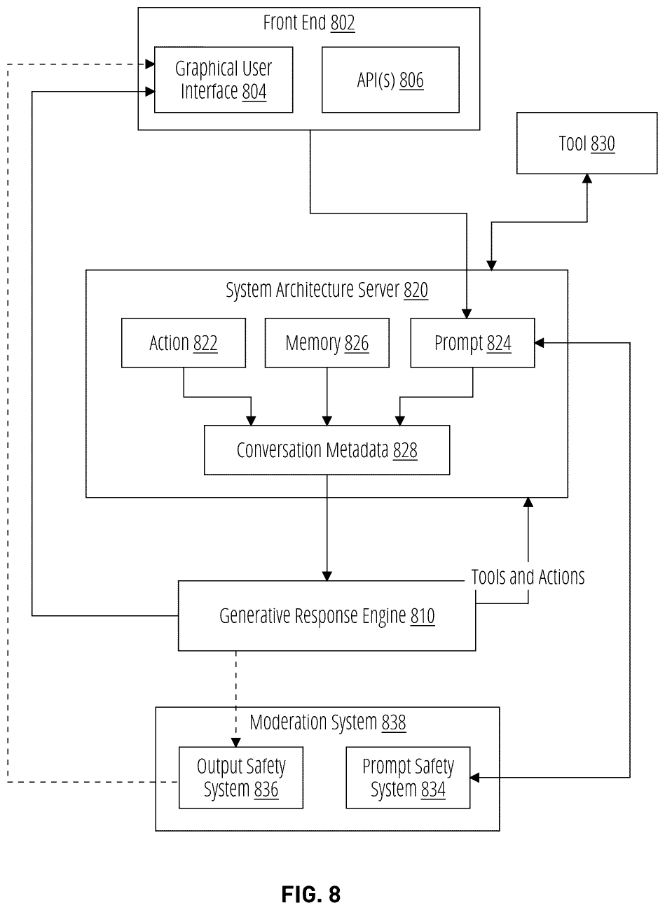

Front end 124 can be a user interface or an application programming interface (API) (see API 806 in FIG. 8) that receives a prompt that instructs visual media generative response engine 100 regarding the desired output visual media. The prompt can include prompt text 108 and/or prompt frame 110. In some embodiments, text is required as part of the prompt, but one or more frames of visual media can optionally be provided. As will be addressed later, the prompt can also include a variety of other inputs that can specify visual formats such as resolution and aspect ratio, among other attributes.

The prompt, received by front end 124, is passed to input layer 122. Input layer 122 is responsible for determining how to handle some aspects of the prompt and to determine attributes of the visual format of the visual media (which may or may not have been provided via inputs into front end 124). More specifically, portions of the prompt can result in several types of inputs into the diffusion-transformer layer 114. Prompt text 108 is provided to diffusion-transformer layer 114 as an embedding created by embedding layer 112. But prompt frames 110 might be provided to diffusion-transformer layer 114 as an embedding provided by embedding layer 112 or as an encoded frame provided by encoding layer 106. Input layer 122 determines to send select frames to encoding layer 106 when those frames should be part of the output visual media and sends frames that are provided to articulate a concept to embedding layer 112. This distinction will be addressed in more detail herein. Front end 124 also can receive inputs that define one or more of duration, resolution, and aspect/or ratio 126.

As illustrated in FIG. 1, input layer 122 also generates noisy frames 102 for input into encoding layer 106. The noisy frames 102 are used to communicate the number of frames that should be in the output visual media, the aspect ratio, and the resolution. Accordingly, input layer 122 determines a length of the to-be-output visual media and supplies the necessary number of frames to make up the visual media. If the output is a single image, only one frame is provided. If the output is a 20 second video at 30 frames per second (fps), 60 frames are provided. In some embodiments, input layer 122 determines the aspect ratio, length, and resolution from explicit inputs provided into front end 124. In some embodiments, input layer 122 infers the aspect ratio, length, and resolution from other prompts.

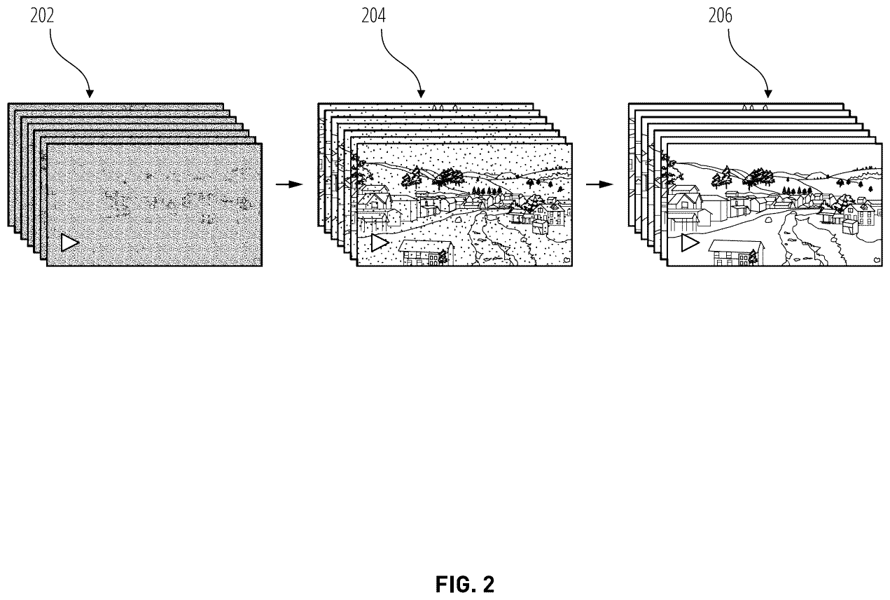

The noisy frames 102 are a typical input to diffusion models, which work to iteratively denoise a random noise pattern based on the prompt to generate an image that is based on the prompt. A diffusion model refers to a type of generative model used in machine learning that learns to generate data by gradually denoising a signal. It starts with a distribution of random noise and, through a series of steps, progressively refines this noise towards data with the desired characteristics, mimicking a process of reverse diffusion. This approach is particularly notable for its ability to generate high-quality, detailed images. FIG. 2 illustrates this process by showing noisy frames 202 that are input into a diffusion model, in this case, a diffusion-transformer, which gradually denoises the frames to result in iteratively denoised frames 204 and eventually output frames 206.

In some embodiments, as illustrated in FIG. 1, the inputs (noisy frame 102, prompt text 108, prompt frame 110) are all transformed into a simplified representation by either encoding pixel-based images or embedding some prompt frames and prompt text. Encoding layer 106 reduces the dimensionality and simplifies the representation of image frames in pixel space into a compressed vector-type representation. Images tend to include a lot of redundant information since adjacent pixels in frames often exhibit high similarity. For example, in many images, a background in one part of an image tends to share attributes of the background in another part of the image (e.g., think of the sky as a background for part of an image; while there is some variation in how the sky appears across an image, there is also a lot of similarity in the sky across most images, and when looking at a pixel-by-pixel basis there is even more similarity between pixels close to one another). This redundant information is compounded in video across frames since each frame in a video is an image with only minor variations from the previous and subsequent frames.

Encoding layer 106 can receive noisy frames 102 and prompt frames 110. Both noisy frames 102 and prompt frames 110 are processed in a similar fashion by encoding layer 106, except that prompt frames 110 do not have noise added. Note that not all prompt frames 110 are provided to encoding layer 106. Some prompt frames 110 can be provided to embedding layer 112.

Encoding layer 106 can be a variational autoencoder (VAE) which is a generative model that use the principles of Bayesian inference to generate new data points. Variational autoencoders encode data into a lower-dimensional space and then decode it back (patch decoder layer 120). Encoding layer 106 processes input visual media by compressing frames of the visual media spatially and temporally. When the visual media is a video, the frames are divided into groups of four adjacent frames and encoded together. This compression mitigates the redundancy inherent in video data, where adjacent pixels and frames often exhibit high similarity. By reducing the number of pixels that the diffusion transformers need to process, the visual encoder enhances computational efficiency and facilitates the handling of high-resolution videos. Image encoders streamline the complexity of data into more manageable representations, facilitating a more efficient generation process in terms of both computational resources and time.

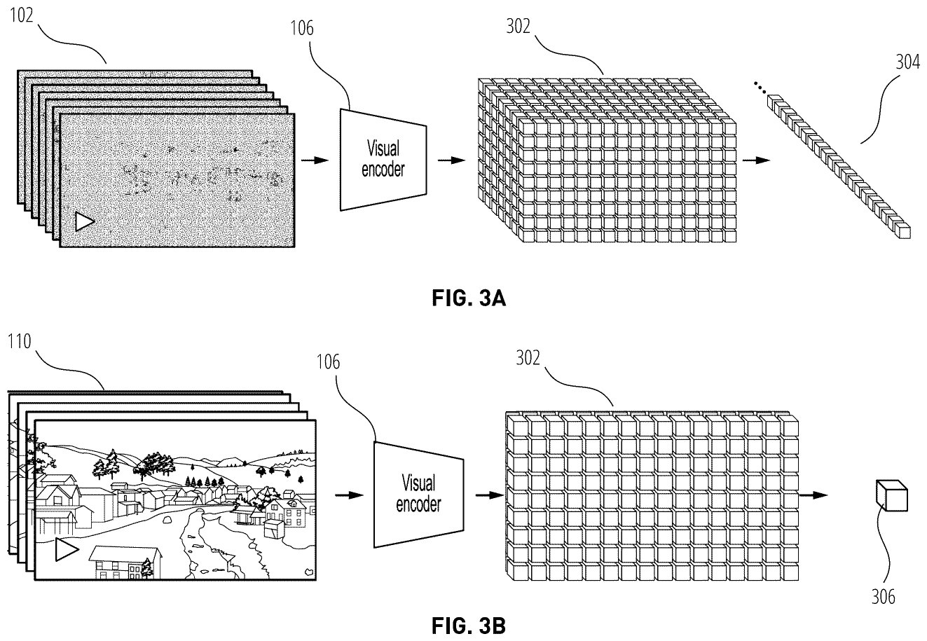

FIG. 3A and FIG. 3B illustrate examples of encoding noisy frames 102 and prompt frames 110 into a collection of spacetime patches. Encoding layer 106 encodes frames into space-time patches, which effectively segment the video into manageable cuboidal units that encompass both spatial (height and width) and temporal (time) dimensions. While FIG. 3A and FIG. 3B are illustrated separately, this is for illustration purposes and in most embodiments, prompt frames 110 would be combined, in order, with noisy frames 102. Often, prompt frames 110 will be arranged as the first or last frame or at some other specific location indicated by the prompt.

These spacetime patches from noisy frames 102 and any prompt frames 110 are then flattened into a single vector by vector representation layer 104 to generate the basis for subsequent processing by diffusion-transformer layer 114. This tokenization method ensures that each patch can reference and interact with all other patches across the entire video, fostering a high degree of coherence and continuity.

FIG. 3A illustrates converting noisy frames 102 (in groups of four frames) into spacetime patches 302, and then generating vector of latent representations 304. FIG. 3B illustrates converting prompt frame 110 (up to four prompt frames) into spacetime patches 302 and generating latent representation of input frame 306.

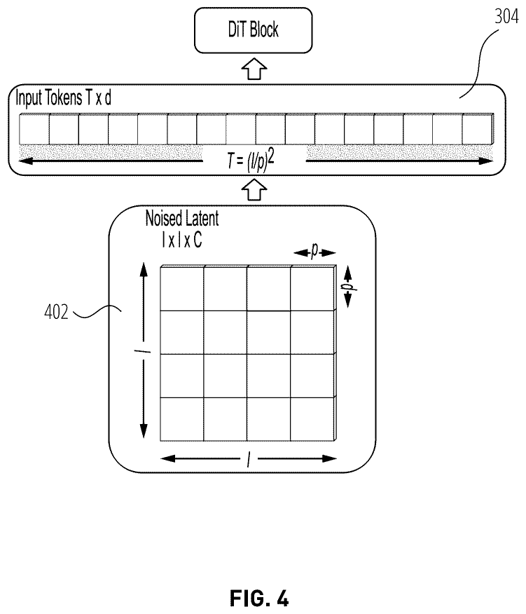

FIG. 4 illustrates the vector of latent representations in greater detail in accordance with some embodiments of the present technology. In particular, FIG. 4 illustrates vector of latent representations 304 which is made up of latent representations of spacetime patches 402. Latent representations of spacetime patches 402 represents the latent embedding of a frame (or group of 4 consecutive frames) of the input video, after it has been processed by the visual encoder. The latent representation has spatial dimensions (I x I) and C channels. This format comes from compressing the video into a compact latent space, reducing redundancy while preserving the core visual and temporal information.

Latent representations of spacetime patches 402 are divided into smaller, non-overlapping patches of size p×p. Each patch corresponds to a portion of the spatial and temporal dimensions of the video. This patch-based processing reduces the computational complexity of handling high-dimensional video data. The number of patches generated from the latent is proportional to (I/p)². This represents the number of patches extracted from the spatial dimensions of the latent.

After the frame or group of frames has been processed by the patch decoder layer 120, the latent representations of spacetime patches 402 are flattened by vector representation layer 104 into a 1D sequence of T tokens, where T=(I/p)². This sequence can be processed by a transformer model. Each token in the sequence has a feature dimensionality of d, which encodes the visual and temporal features of the corresponding patch.

As introduced above, prompt text 108 and some prompt frames 110 are turned into embeddings by embedding layer 112. Embedding layer 112 can be a multi-modal modal, such as Contrastive Language-Image Pretraining (CLIP) or can be multiple embedding models, such as an embedding model for images and an embedding for text.

CLIP is a model developed by OPENAI that aligns textual embeddings and visual embedding through a training framework centered on contrastive learning. CLIP utilizes a dual-encoder architecture, comprising a text encoder and an image encoder, trained simultaneously on a large dataset of image-text pairs. Each encoder generates embeddings in a shared feature space, allowing for the alignment of corresponding images and text based on semantic similarity. During training, the model is optimized to assign higher similarity scores to matching image-text pairs while minimizing scores for mismatched pairs. In other words, CLIP will create similar embeddings for an image and text describing that image. The embedding space created by CLIP is effectively a translation space between text and images.

The embeddings created by embedding layer 112 and the spacetime patches created by the encoding layer 106 are fused by vector representation layer 104. The effect of the encoding layer 106 and embedding layer 112 are to create latent representations of the inputs. Vector representation layer 104 takes the latent representations and flattens them into one or more vectors that are latent representations of the visual media to be generated. Most of the vector of latent representations consists of representations of noisy frames 102, but perhaps the first or last representation (or some other specific frame) might one of a latent representation of input frame depicted as 306 in FIG. 3B. Additionally, some interval of representations in the vector of latent representations will be from the the prompt embeddings. The prompt embeddings can communicate the intent of the prompt to the diffusion-transformer layer. As described above, some prompt embeddings are derived from the text prompt, and some prompt embeddings can be derived from an image prompt.

Diffusion-transformer layer 114 receives the vector of latent representations and processes frames of the entire visual media concurrently. Importantly, as will be addressed in greater detail herein, diffusion-transformer layer 114 processed frames of the visual media with knowledge of the other frames in the visual media. This holistic approach allows for comprehensive spatial and temporal coherence across the generated video, ensuring consistency and realism in motion and object interactions.

Linearization layer 118 receives the output from diffusion-transformer layer 114, which is a latent representation of denoised frames, and arranges them back into a vector, including a sequence of denoised frames. Patch decoder layer 120 is effectively the opposite of encoding layer 106, and it converts the frames from its latent representation back into a pixel representation. Recall that groups of four frames were condensed into a single representation. Therefore, patch decoder layer 120 expands any representation into four frames in a pixel representation.

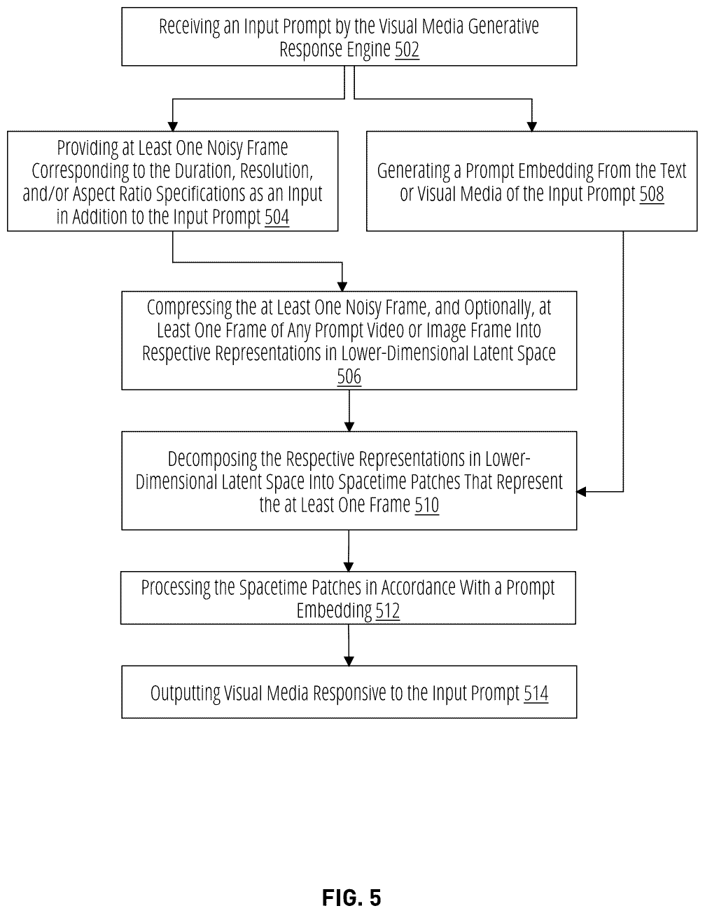

FIG. 5 illustrates an example process for generating visual media of disparate durations, resolutions, and aspect ratios using a visual media generative response engine in accordance with some embodiments of the present technology. Although the example process depicts a particular sequence of operations, the sequence may be altered without departing from the scope of the present disclosure. For example, some of the operations depicted may be performed in parallel or in a different sequence that does not materially affect the function of the process. In other examples, different components of an example device or system that implements the process may perform functions at substantially the same time or in a specific sequence.

While some operations are addressed as being performed by a particular component or service, this is for explanation purposes only, and it should be appreciated that reference to a specific component or service does not prevent the possibility that a higher-level device or service or a different device or service can perform the same function. It is explicitly intended that if a function is performed by a service on a system, device, container, or virtual machine, it should be appreciated that the system, device, container, or virtual machine is performing that function as part of executing the service.

According to some examples, the method includes receiving an input prompt by the visual media generative response engine at block 502. For example, input layer 122 illustrated in FIG. 1 may receive an input prompt from a user interface or an application programming interface (API). In some embodiments, the input layer 122 can be part of front end 124.

In some embodiments, the input prompt is text. In some embodiments, the input prompt includes visual media and the text. In some embodiments, the input prompt can also include duration, resolution, aspect ratio, style, and story boarding specifications, etc.

As introduced herein, one advancement in the state of the art that is provided by the present technology is the ability to generate visual media in a variety of durations, resolutions, and/or aspect ratios. In some embodiments, the duration, resolution, and/or aspect ratio for visual media can be determined from a natural language prompt provided in front end 124. In some embodiments, a user interface or API can specify a desired duration, resolution, and aspect/or ratio 126.

According to some examples, the method includes providing at least one noisy frame corresponding to the duration, resolution, and/or aspect ratio specifications as an input to a diffusion-transformer in addition to the input prompt at block 504. For example, the input layer 122 illustrated in FIG. 1 may provide at least one noisy frame corresponding to the duration, resolution, and/or aspect ratio specifications as an input in addition to the input prompt. As addressed above, diffusion models start with noisy frames and gradually de-noise the frames into the desired output. Thus providing the at least one noisy frame can be a method to control the resolution and/or the aspect ratio of generated videos by arranging randomly-initialized patches in an appropriately-sized grid to result the at least one noisy frame. The duration of the visual media can be controlled by the number of noisy frames provided. If a still image is the desired visual media, only one frame is required, but if a 20 second video at 60 frames-per-second is desired, 1,200 frames need to be provided.

As will be addressed in greater detail herein, the visual media generative response engine has been trained on native video at a variety of different frame rates, aspect ratios, durations, resolutions, etc., and therefore can also output visual media with a variety of different attributes too.

According to some examples, the method includes compressing the at least one noisy frame into respective representations in lower-dimensional latent space at block 506. For example, the encoding layer 106 illustrated in FIG. 1 may compress the at least one noisy frame, and optionally, one or more frames of any prompt video or image frame, into respective representations in lower-dimensional latent space.

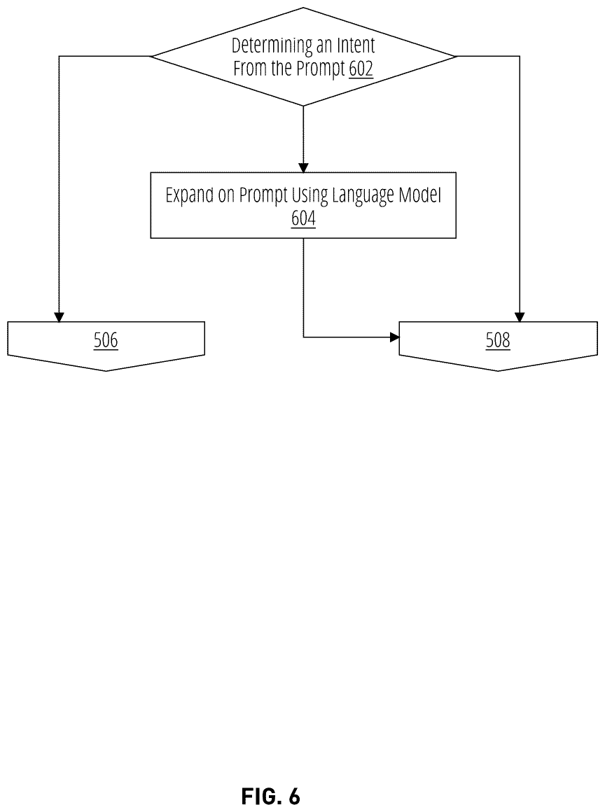

The prompt also needs to be translated into a latent representation. Another innovation provided by the present technology is that visual media generative response engine 100 can generate visual media from prompts that include visual media as well as text. Another innovation of the present technology is that visual media generative response engine 100 can incorporate visual media inputs into an output visual media. The rest of the description of FIG. 5 will address embodiments wherein the prompt may or may not include visual media, while the description of FIG. 6 will address embodiments wherein visual media included in the prompt is incorporated into an output visual media.

According to some examples, the method includes generating a prompt embedding from the text and/or visual media of the input prompt at block 508. For example, the embedding layer 112 illustrated in FIG. 1 may generate a prompt embedding from the text and/or visual media of the input prompt. In some embodiments, the embedding layer is a Contrastive Language-Image Pretraining (CLIP) embedding layer. In some embodiments, the embedding layer can use a different embedding model for images and another embedding model for text.

Thus the output of embedding layer 112 is one or more embeddings derived from the prompt. In a simple example, if the prompt is a text prompt, embedding layer 112 might output a single embedding. Or, if the prompt were a text prompt defining action or a story to be represented by a video, the text prompt might be broken into several different text prompts describing frames that would transition a video through the action or story. In this example embedding layer 112 would output several embeddings derived from the several text prompts. If the prompt were to provide visual media as an input, with text prompting the visual media generative response engine to generate a video using the same style features as portrayed in the visual media, the embedding layer might also output an embedding based on one or more frames of the visual media. (All of this implies some logic occurring at input layer 122, which is addressed in greater detail with respect to FIG. 6).

Now visual media generative response engine 100 has encoded noisy frames 102 that will make up the output of visual media generative response engine 100 and has translated prompts into prompt embeddings, which are collectively representations of the noisy frames 102 and prompts in a latent form that need to be combined into an input that can be efficiently processed by diffusion-transformer layer 114. According to some examples, the method includes decomposing the respective representations in lower-dimensional latent space into spacetime patches that represent the at least one frame at block 510. For example, the vector representation layer 104 illustrated in FIG. 1 may decompose the respective representations in lower-dimensional latent space into spacetime patches that represent the at least one frame. The spacetime patches are included in a vector of spacetime patches representing frames in the output visual media. In some embodiments, such as when the prompts correspond to a description of frames to occur through out an output video, these prompts would be interspersed among the noisy frames. In some embodiments, an embedding based on the prompt might be interleaved among the noisy frames at a predefined interval (e.g., every 6 frames, every 10 frames, every 15 frames, every 20 frames, etc.). In the vector of spacetime patches, a first spacetime patch might be made up of an embedding from the prompt, followed by several spacetime patches made up of encoded noisy frames, followed by another embedding, followed by more noisy frames, etc. This vector made up from the spacetime patches is depicted as vector of latent representations 304 in FIG. 3A and FIG. 4.

According to some examples, the method includes processing the spacetime patches in accordance with a prompt embedding at block 512. For example, the diffusion-transformer layer 114 illustrated in FIG. 1 may process the spacetime patches in accordance with a prompt embedding. In some embodiments, the diffusion-transformer layer includes a plurality of diffusion-transformer processing units that respectively process respective spacetime patches in parallel. This, too, is among the innovative features of the present technology. Most transformer architectures process tokens in series, but the present technology processes all of the spacetime patches in parallel predicting all tokens at the same time. Since some of those tokens are part of spacetime patches derived from the prompt, diffusion-transformer layer 114 works to ensure consistency among the spacetime patches and thereby influences diffusion-transformer layer 114 to output visual media consistent with the prompt.

According to some examples, the method includes outputting visual media responsive to the input prompt at block 514. For example, the visual media generative response engine 100 illustrated in FIG. 1 may output visual media responsive to the input prompt. As addressed with respect to FIG. 1, before the visual media can be output, a linearization layer 118 arranges the outputs from the diffusion-transformer processing units back into spacetime patches, now processed to be de-noised, which is a latent representation of the output visual media. Then patch decoder layer 120 decodes the latent representation of the output visual media into pixel frames that make up traditional visual media.

The output visual media matches the duration, resolution, and/or aspect ratio specifications. When the duration is zero seconds, and the visual media responsive to the input prompt is a still image-a single frame.

FIG. 6 illustrates an example process illustrating additional functions of the input layer in accordance with some embodiments of the present technology. Although the example process depicts a particular sequence of operations, the sequence may be altered without departing from the scope of the present disclosure. For example, some of the operations depicted may be performed in parallel or in a different sequence that does not materially affect the function of the process. In other examples, different components of an example device or system that implements the process may perform functions at substantially the same time or in a specific sequence.

As introduced above, a prompt can include visual media. While FIG. 5 addressed an an embodiment wherein the prompt is input to embedding layer 112, FIG. 6 adds that input layer 122 can enhance prompts, and that portions of prompts can be input to encoding layer 106 for encoding along with the noisy frames 102.

According to some examples, the method includes determining an intent from the prompt at decision block 602. For example, the input layer 122 illustrated in FIG. 1 may determine an intent from the prompt. For example, input layer 122 can determine whether the intent of the prompt is to generate visual media that includes a frame or portion of a frame provided in the prompt. If the intent of the prompt is to include a frame from the prompt in the output visual media, input layer 122 can provide that frame for encoding so that it can be provided to diffusion-transformer layer 114 as described with respect to block 506. On the other hand, an input visual media prompt could be provided to help articulate the vision of the visual artist providing the prompt, and in such an instance a frame from the input visual media prompt does not need to be included in the output visual media. In such an instance, the visual media can be provided to embedding layer 112 as described with respect to block 508.

Another aspect of determining the intent of the prompt is to determine whether the prompt should be modified or enhanced. In some embodiments, a prompt might not include a lot of detail, yet, diffusion-transformer layer 114 will provide better and more consistent results when provided with highly descriptive prompts. Accordingly, in some embodiments, input layer 122 can send the prompt to a language model to generate a more detailed prompt at block 604. In some embodiments, an input prompt might articulate a vague progression for a desired output visual media. In such embodiments, input layer 122 can send the prompt to a language model to generate a series of prompts that act as storyboard that describes specific frames that might occur in the progression suggested by the prompt.

For example, an intent to include at least one frame from an input visual media could be found in a prompt that includes the visual media and the text that instructs visual media generative response engine 100 to generate a video by using some attribute in the input visual media or modifying some aspect of the visual media. Accordingly, input layer 122 would provide the image to encoding layer 106 to be provided to diffusion-transformer layer 114 along with the noisy frames as addressed with respect to block 506. The output from diffusion-transformer layer 114 would be a video responsive to the input prompt that includes the image, at least a part of the image that the prompt desires to be kept, as part of the video responsive to the input prompt. In a more specific example, the input visual media might include a picture of a toy truck, and the prompt might request the toy truck to be seen driving around a beach. The output would extract the toy truck from the input visual media and re-render the rest of the visual media while rendering additional frames.

In another example, the input prompt can include a prompt video as the visual media and the text instructs visual media generative response engine 100 to generate an extended video in a time-forward or time-backward dimension from the prompt video. Accordingly, input layer 122 would provide all of the frames of the input video to encoding layer 106 and locate the frames making up the input video in the proper sequence with respect to the noisy frames. In other words, if the prompt requests that the output video extend the input video, the input frames would be located first, and the noisy frames that will be generated into new frames to extend the input video would be located subsequent to the input frames. The output from diffusion-transformer layer 114 would be a video responsive to the prompt that extended the input video with additional frames.

In another example, the input prompt includes at least two prompt visual media items and the text instructs visual media generative response engine 100 to create a blended video that blends from a first visual media item to the second visual media item to result in a blended video. Accordingly, input layer 122 would provide at least one frame of the first input visual media and at least one frame of the second visual media to encoding layer 106, and locate the frames making up the first and second visual media in the proper sequence with respect to the noisy frames-in other words, the noisy frames would be located in between and separate the frames from the first and second visual media so that diffusion-transformer layer 114 can generate frames that blend between the two input visual media.

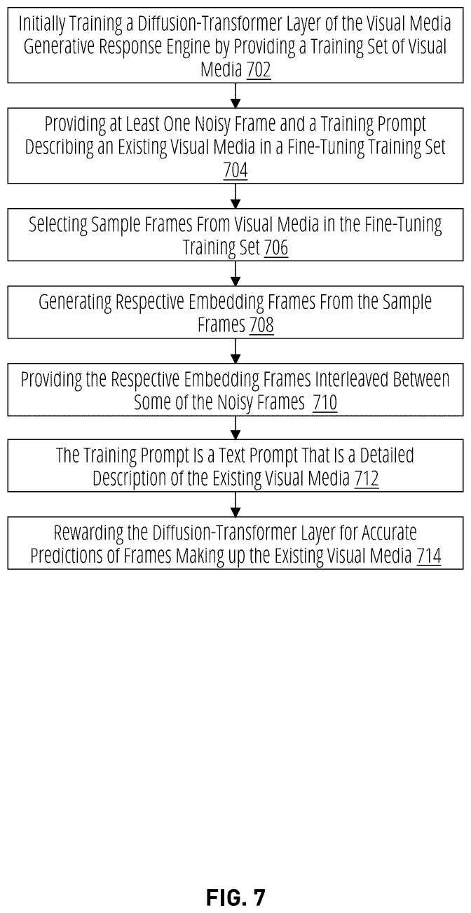

FIG. 7 illustrates an example process for training a visual media generative response engine in accordance with some embodiments of the present technology. Although the example process depicts a particular sequence of operations, the sequence may be altered without departing from the scope of the present disclosure. For example, some of the operations depicted may be performed in parallel or in a different sequence that does not materially affect the function of the process. In other examples, different components of an example device or system that implements the process may perform functions at substantially the same time or in a specific sequence.

Along with the several innovative aspects pertaining to the function and performance of visual media generative response engine 100, some of these innovative aspects have their root in the training of visual media generative response engine 100. More specifically, visual media generative response engine 100 is trained on native visual media. And that visual media includes visual media of a variety of aspect ratios, resolutions, and lengths, which presents several technical challenges.

According to some examples, the method includes initially training a diffusion-transformer layer of the visual media generative response engine by providing a training set of visual media at block 702. The visual media is native visual media including visual media of disparate durations, resolutions, and/or aspect ratios. By native visual media it is meant that the visual media is not edited for the sake of training the visual media generative response engine.

Most machine learning models require the input data to be uniform. Therefore, prior attempts at image and video models provided input in a uniform resolution, aspect ratio, and length of video. However, this can result in distortions in the visual media. Whether scaling or cropping frames, the images in frames can be distorted. Even truncating a video distorts the beginning and end of a concept depicted by the visual artist.

An important and desirable consequence of training on native visual media is that the visual media generative response engine learns accurate proportions and framing. When visual media is cropped and scaled to fit typical visual models, distortions in proportions and framing can occur. The present technology can avoid these consequences by training using native visual media.

Another important and desirable consequence of the design of the visual media generative response engine (in particular the attention mechanism) is that it can learn how objects interact in the real world. In some sense, the visual media generative response engine is a visual learning model that can learn to simulate physical interactions of objects in the physical world. In particular, the visual media generative response engine can learn the cause and effect of object interactions and replicate them in the visual media that it generates. For example, in a video of an artist painting, the model can show the interaction between the brush and the canvas during the brush stroke, resulting in applied paint and texture. The video can progress while maintaining the results of the brush stroke and building on top of it. In this way, the model is able to update object states permanently throughout the visual media.

The visual media generative response engine's ability to maintain 3D consistency and object permanence ensures that generated videos exhibit stable and realistic object interactions and movements. This coherence is essential for applications where the integrity of the visual narrative and object states is paramount, such as in storytelling, education, and simulation training.

After this training of the visual media generative response engine on a large quantity of native visual media, the visual media generative response engine can be fine tuned.

According to some examples, the method includes providing at least one noisy frame and a training prompt describing an existing visual media in a fine-tuning training set at block 704.

According to some examples, the method includes selecting sample frames from visual media in the fine-tuning training set at block 706.

According to some examples, the method includes generating respective embedding frames from the sample frames at block 708. The respective embedding frames are generated using a Contrastive Language-Image Pretraining (CLIP) technique. An important aspect of the fine-tuning of the visual media generative response engine is training on CLIP embeddings. Training on CLIP embeddings provides the diffusion-transformer layer the ability to receive visual prompts to guide the generation of the visual media. For example, training on CLIP embeddings enables the ability of the visual media generative response engine to create visual media that can transition from one set of input frames to another set of input frames, to re-render input frames, etc.

According to some examples, the method includes providing the respective CLIP embedding frames interleaved between some of the noisy frames at block 710. CLIP embeddings from the training prompt can be interleaved in some percentage of the training. For example, CLIP embeddings can be provided in 50% of the training samples. Additionally, text embeddings can also be interleaved in some percentage of the training samples to sensitize the model to the text inputs too.

Finally, the model can be trained using reinforcement learning whereby the method includes generating a training prompt from an image-to-text captioner model that is trained to create a detailed description of the existing visual media at block 712.

The training prompt can be provided to the visual media generative response engine.

According to some examples, the method includes rewarding the diffusion-transformer layer for accurate predictions of frames making up the existing visual media at block 714. The diffusion-transformer layer of the visual media generative response engine receives a plurality of frames including noisy frames and respective embeddings interleaved with the noisy frames, whereby the diffusion-transformer layer learns to predict noisy frames that are consistent with the respective embeddings.

FIG. 8 illustrates an example system supporting a generative response engine during inference operations in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

The generative response engine 810 is an artificial intelligence (AI) that can generate content in response to a prompt. The prompt can be from a human or a software entity (AI or applications). The prompt is generally in natural language but could be in code, including binary. Some examples of the generative response engine can include language models that generate language, such as CHATGPT, or other models, such as DALL-E, which generates images, and SORA, which generates videos. CHATGPT, DALL-E, and SORA are all provided by OPENAI, but the generative response engine is not limited to AI provided by OPENAI. The generative response engine can also be any type of generative AI and can include AI developed using various architectures such as diffusion models and transformers (e.g., a generative pre-trained transformer) and combinations of models.

In some instances, a language model, such as CHATGPT, can receive prompts to output images, video, code, applications, etc., which it can provide by interfacing with one or more other models, as will be addressed further herein.

Users and applications can interact with the generative response engine 810 through the front end 802. The front end 802 serves as the interface and intermediary between the user and the generative response engine. It encompasses the graphical user interface 804 and Application Programming Interfaces (APIs) 806 that facilitate communication, input processing, and output presentation. Generally, users interact through a graphical user interface 804 that often includes a conversational interface, and applications interact through the API 806, but this is not a requirement.

The graphical user interface 804 is the platform through which users interact with the generative response engine 810. It can be a web-based chat window, a mobile application, or any interface that supports data input and output. The graphical user interface 804 facilitates a conversation between the user and the generative response engine, as the user provides prompts in the graphical user interface 804 to which the generative response engine responds and presents those responses in the graphical user interface 804. In some embodiments, graphical user interface 804 presents a conversational interface, which has attributes of a conversation thread between a user account and generative response engine 810.

The graphical user interface 804 is configured to perform input handling, context management, and output presentation. The type of inputs that can be received can be relative to the specifics of the generative response engine 810. But even when a model doesn't directly accept certain types of inputs, the front end 802 might be able to receive different types of inputs, which can be converted to inputs that are accepted by the generative response engine 810. For example, a language model is generally configured to accept text, but the front end 802 can accept voice and convert it to text or accept an image and create a textual representation.

The graphical user interface 804 is also configured to maintain the context of the conversation, which allows for coherent and relevant responses. For example, the graphical user interface 804 is responsible for providing the conversation thread and other relevant context accessible to the front end 802 to the generative response engine along with the specific prompt to the generative response engine. In an example, a conversation between the user account and the generative response engine 810 can have taken several turns (prompt, response, prompt, response, etc.). When the user account provides a further prompt, the graphical user interface 804 can provide that prompt to the generative response engine in the context of the entire conversation.

In another example, the front end 802 might have access to a memory 826 where facts about the user account have been stored. In some embodiments, these facts can have been identified as facts worth storing by the generative response engine and the front end 802 has stored these facts at the direction of the generative response engine. Accordingly, these facts can be provided to the generative response engine 810 along with a user-provided prompt so that the generative response engine has access to these facts when generating a response.

In another example, the graphical user interface 804 might be configured to provide a system prompt along with a user-provided prompt. A system prompt is hidden from the user account and is used to set the behavior and guidelines for the generative response engine. It can be used to define the Al's persona, style, and constraints.

The graphical user interface 804 is also configured to display the responses from the generative response engine, which might include text, code snippets, images, or interactive elements.

In some embodiments, the generative response engine 810 can provide instructions to the front end 802 that instruct the graphical user interface 804 about how to display some of the output from the generative response engine. For example, the generative response engine can direct the graphical user interface 804 to present code in a code-specific format, or to present interactive graphics, or static images. In other examples, the generative response engine can direct the graphical user interface 804 to present an interactive document editor where the graphical user interface 804 can be presented with the document editor so that the user account and the generative response engine can collaborate on the document. In some embodiments, the generative response engine 810 can provide instructions to the front end 802 to record facts in a personalization notepad. Accordingly, the graphical user interface 804 does not always display all of the output of the generative response engine.

As noted above, the front end 802 can also provide one or more application programming interfaces (API(s)) 806. APIs enable developers to integrate the generative response engine's capabilities into external applications and services. They provide programmatic access to the generative response engine, allowing for customized interactions and functionalities.

The APIs 806 can accept structured requests containing prompts, context, and configuration parameters. For example, an API can be used to provide prompts and divide the prompt into system prompts and user prompts. In some embodiments, the APIs 806 can provide specific inputs for which the generative response engine 810 is configured to respond with a specific behavior. For example, an API can be used to specify that it requires an output in a particular format or structured output. For example, in the chat completion API, the API call can specify parameters for the output, such as the max length for the desired output, and specify aspects of the tone of the language used in the response. Some common APIs are for participating in a conversation (Chat Completion API), for providing a single response (Completion API), for converting text into embeddings (Embeddings API), etc. The API can also be used to indicate specific decision boundaries that the generative response engine 810 might be trained to interpret. For example, the moderation API can take advantage of the generative response engine's content moderation decision-making. In the case of the moderation API and others, the API might give access to services other than the generative response engine. For example, the moderation API might be an interface to moderation system 838, addressed below.

Some other common APIs include the Fine-Tuning API, which allows developers to customize models of the generative response engine using their own datasets; the Audio and Speech APIs, which cause the generative response engine to output speech or audio; and the Image Generation API, which causes the generative response engine to output images (which might require utilizing other models).

There can also be APIs that direct the generative response engine to interface with other applications or other generative AI engines. In such cases, the specific application or AI engine might be specified, or the generative response engine might be allowed to choose another application of AI engine to utilize in response to a prompt.

In short, the graphical user interface 804 and the APIs 806 can be used to provide prompts to the generative response engine. Prompts are sometimes differentiated into prompt types. For example, a system prompt can be a hidden prompt that sets the behavior and guidelines for the generative response engine. A user prompt is the explicit input provided by the user, which may include questions, commands, or information.

Sitting in between front end 802 and generative response engine 810 is a system architecture server 820. The function of system architecture server 820 is to manage and organize the flow of data among key subsystems, enabling the generative response engine 810 to generate responses that are contextually relevant, accurate, and enriched with additional information as required.

Action 822 facilitates auxiliary tasks that extend beyond basic text generation. In some embodiments, action 822 can be actions that correspond to an API 806. In some embodiments, action 822 can be agentic actions that the generative response engine 810 decides to take to carry out a user's intent as described in the prompt.

Prompt 824 is the request or command provided by the user account through front end 802. In some embodiments, prompt 824 can be further supplemented by a system prompt and other information that might be included by graphical user interface 804 or API 806. In some embodiments, prompt 824 can even be modified or enhanced by generative response engine 810 as addressed further below. Additionally, as the user account provides prompts and generative response engine 810 provides responses, a conversation thread forms. As the user account provides a new prompt, this is appended to the overall conversation and added to prompt 824. Thus, a user account might think of a first user-provided message as a first prompt and a second user-provided message as a second prompt, and so on, but prompt 824 as perceived by generative response engine 810 can include a thread of user-provided messages and responses from generative response engine 810 in a multi-turn conversation. Generally, prompt 824 will include an entire conversation thread, but in some instances, prompt 824 might need to be shortened if it exceeds a maximum accepted length (generally measured by a number of tokens).

System architecture server 820 can also route prompts and response through moderation system 838, which can be separate or part of system architecture server 820. In some embodiments, prompts are provided to prompt safety system 834 before being provided to generative response engine 810. Prompt safety system 834 is configured to use one or more techniques to evaluate prompts to ensure a prompt is not requesting generative response engine 810 to generate moderated content. In some embodiments, prompt safety system 834 can utilize text pattern matching, classifiers, and/or other AI techniques.

Since prompts can evolve over time through the course of a conversation, consisting of prompts and responses, prompts can be repeatedly evaluated at each turn in the conversation.

Memory 826 can facilitate continuity and personalization in conversations. It allows the system to maintain user-specific context, preferences, or details that may inform future interactions. A memory file can be persisted data from previous interactions or sessions that provide background information to maintain continuity. In some embodiments, memory can be recorded at the instruction of generative response engine 810 when generative response engine 810 identifies a fact or data that it determines should be saved in memory because it might be useful in later conversations or sessions.

Conversation metadata 828 can aggregate data points relevant to the conversation, including user prompt 824, action 822, and memory 826. This consolidated information package serves as the input for generative response engine 810. Conversation metadata 828 can label parts of a prompt as user provided, generative response engine provided, a system prompt, memory 826, data from action 822 or tool 830 (addressed below).

The generative response engine is the core engine that processes inputs (from system architecture server 820) and generates outputs. In some embodiments, the generative response engine is a Generative Pre-trained Transformer (GPT), but it could utilize other architectures.

A core feature of the generative response engine 810 is to generate content in response to prompts. When the generative response engine 810 is a GPT, it is configured to receive inputs from front end 802 that provide guidance on a desired output. The generative response engine can analyze the input and identify relevant patterns and associations in the data, and it has learned to generate a sequence of tokens that are predicted as the most likely continuation of the input. The generative response engine 810 generates responses by sampling from the probability distribution of possible tokens, guided by the patterns observed during its training. In some embodiments, the generative response engine 810 can generate multiple possible responses before presenting the final one. The generative response engine 810 can generate multiple responses based on the input, and these responses are variations that the generative response engine 810 considers potentially relevant and coherent.

In some embodiments, the generative response engine 810 can evaluate generated responses based on certain criteria. These criteria can include relevance to the prompt, coherence, fluency, and sometimes adherence to specific guidelines or rules, depending on the application. Based on this evaluation, the generative response engine 810 can select the most appropriate response. This selection is typically the one that scores highest on the set criteria, balancing factors like relevance, informativeness, coherence, and content moderation instructions/training.

In some embodiments, an instruction provided by an API 806, a system prompt, or a decision made by generative response engine 810 can cause the generative response engine 810 to interpret a prompt and re-write it or improve the prompt for a desired purpose. For example, generative response engine 810 can determine to take a prompt to make a picture and enhance the prompt to yield a better picture. In these instances, generative response engine 810 can generate its own prompts, which can be provided to a tool 830 or provided to generative response engine 810 to yield a better output response than the original prompt might have.

The generative response engine 810 can also do more than generate content in response to a prompt. In some embodiments, the generative response engine 810 can utilize decision boundaries to determine the appropriate course of action based on the prompt. In some examples, a decision boundary might be used to cause the generative response engine to recognize that it is being asked to provide a response in a particular format such that it will generate its response constrained by the particular format. In some examples, a decision boundary can cause the model to refuse to generate a responsive output if the decision is that the responsive output would violate a moderation policy. In some examples, the decision boundary might cause the generative response engine to recognize that it needs to interface with another AI model or application to respond to the prompt. For example, when the generative response engine is a language model, it might recognize that it is being asked to output an image, and therefore, it needs to interface with a model that can output images to provide a response to the prompt. In another example, the prompt might request a search of the Internet before responding. The generative response engine can use a decision boundary to recognize that it should conduct a search of the Internet and use the results of that search in responding to the prompt. In another example, the prompt might request that the generative response engine take an agentic action on behalf of the user by interacting with a third-party service (e.g., book a reservation for me at . . . ), and the generative response engine can utilize a decision boundary to recognize that it needs to plan steps to locate the third-party service, contact the third-party service, and interact with the third-party service to complete the task and then report back to the user that the action has been completed.

When generative response engine 810 determines that it should take an agentic action on behalf of the user or it should call a tool to aid in providing a quality response to the user account, the generative response engine 810 might call a tool 830 or cause an action 822 to be performed. As indicated above, tools 830 can include internet browsers, editors such as code editors, other AI tools etc. Actions 822 are actions that the generative response engine 810 can cause to be performed, perhaps using tool 830. As used herein actions 822 should be considered to cover a broad array of actions that generative response engine 810 can perform with or without tools 830. Tools 830 are considered to cover a wide variety of services and software that encompass tools such as a computer operating system such that the generative response engine 810 can control the computer operating system on the user's behalf, to robotic actuators, to search browsers and specific applications.

Additionally, the generative response engine 810 can also generate portions of responses that are not displayed to the user. For example, the generative response engine 810 can direct the front end 802 to provide specific behaviors, such as directions for how to present the response from the generative response engine 810 to the user account. In another example, the generative response engine 810 can provide response portions dictated by an API, where portions of the response to the API might be for the consumption of the calling application but not for presentation to the end user.

In some embodiments, the output of generative response engine can be further analyzed by output safety system 836. While generative response engine 810 can perform some of its own moderation, there can be instances where it is desired to have another service review outputs for compliance with the moderation policy. The use of dashed lines in FIG. 8 differentiates a path using output safety system 836 and not using output safety system 836.

While FIG. 8 shows responses being provided back to front end 802 directly, in some embodiments, the responses might be returned by way of system architecture server 820.

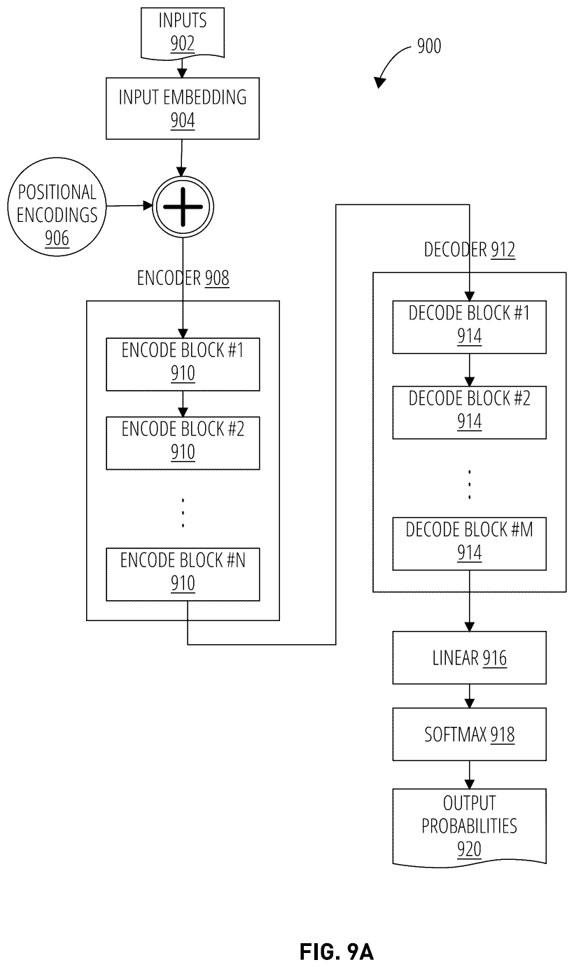

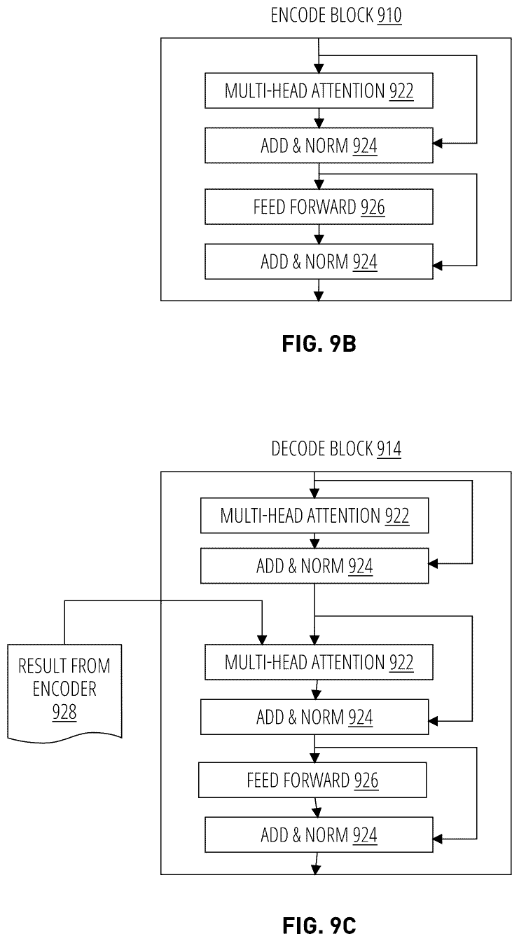

FIG. 9A, FIG. 9B, and FIG. 9C illustrates an example transformer architecture in accordance with some embodiments of the present technology. Examples of ML models that use a transformer neural network (e.g., transformer architecture 900) can include, e.g., generative pretrained transformer (GPT) models and Bidirectional Encoder Representations from Transformer (BERT) models. The transformer architecture 900, which is illustrated in FIG. 9A, FIG. 9B, and FIG. 9C, includes inputs 902, input embedding block 904, positional encodings 906, encoder 908 including encode blocks 910, decoder 912 including decode blocks 914, linear block 916, softmax block 918, and output probabilities 920.

Input embedding block 904 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 904 can be learned embeddings to convert the input tokens and output tokens to vectors of dimension that have the same dimension as the positional encodings, for example.

Positional encodings 906 provide information about the relative or absolute position of the tokens in the sequence. According to certain non-limiting examples, positional encodings 906 can be provided by adding positional encodings to the input embeddings at the inputs to the encoder 908 and decoder 912. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 908 can use stacked self-attention and point-wise, fully connected layers. Encoder 908 can be a stack of N identical layers (e.g., N=6), and each layer can be an encode block, as illustrated by encode block 910 shown in FIG. 9B. Each encode block 910 has two sub-layers: (i) a first sub-layer has a multi-head attention block 922 and (ii) a second sub-layer has a feed forward block 926, which can be a position-wise fully connected feed-forward network. The feed forward block 926 can use a rectified linear unit (ReLU).

Encoder 908 uses a residual connection around each of the two sub-layers, followed by an add & norm block 924, which performs normalization. For example, the output of each sub-layer can be LayerNorm (x+Sublayer (x)). To facilitate these residual connections, all sub-layers in the model, as well as the embedding layers, produce output data having a same dimension.

Similar to encoder 908, decoder 912 uses stacked self-attention and point-wise, fully connected layers. Decoder 912 can also be a stack of M identical layers (e.g., M=6), and each layer can be a decode block, as illustrated by decode block 912 shown in FIG. 9B. In addition to the two sub-layers (i.e., the sublayer with multi-head attention block 922 and the sub-layer with feed forward block 926) found in encode block 910, decode block 914 can include a third sub-layer, which performs multi-head attention over the output of the encoder stack. Similar to encoder 908, decoder 912 uses residual connections around each of the sub-layers, followed by layer normalization. Additionally, the sub-layer with multi-head attention block 922 can be modified in the decoder stack to prevent positions from attending to subsequent positions. This masking, combined with the fact that the output embeddings are offset by one position, can ensure that the predictions for position i can depend only on the known output data at positions less than i.

Linear block 916 can be a learned linear transformation. For example, when transformer architecture 900 is being used to translate from a first language into a second language, linear block 916 can project the output from the last decode softmax block 918 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 918 then turns the scores from linear block 916 into output probabilities 920 (which add up to 1.0). In each position, the index provides for the word with the highest probability, and then maps that index to the corresponding word in the vocabulary. Those words then form the output sequence of transformer architecture 900. The softmax operation is applied to the output from linear block 916 to convert the raw numbers into output probabilities 920 (e.g., token probabilities).

Thus far, the present description has focused on innovations pertaining to the visual media generative response engine itself. As a novel generative tool, the visual media generative response engine is further accompanied by several innovative interface features. The following description turns to features of interfaces for providing inputs and editing outputs from the visual media generative response engine. While the following discussion addresses using these interfaces with the visual media generative response engine described herein, it is explicitly contemplated that these interfaces have utility with other visual media creation tools, and therefore, no statement made herein should be considered to limit the interfaces described herein to be used only with the visual media generative response engine described herein unless explicitly stated.

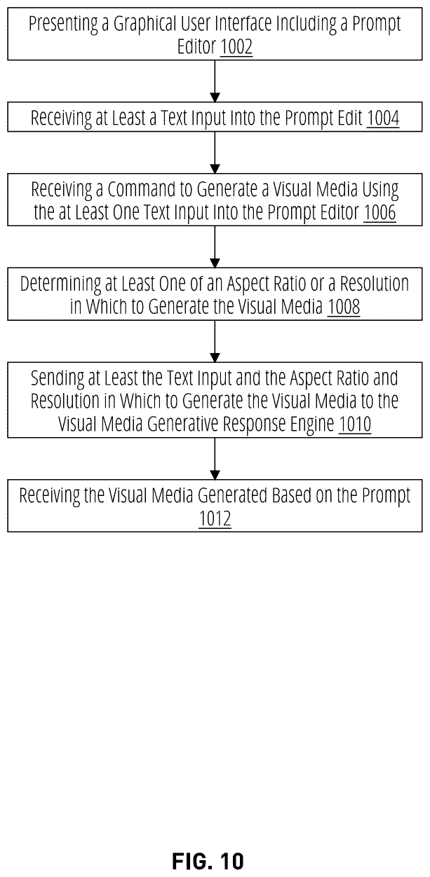

FIG. 10 illustrates an example process for presenting and using a graphical user interface to create a prompt for generating visual media in accordance with some embodiments of the present technology. Although the example process depicts a particular sequence of operations, the sequence may be altered without departing from the scope of the present disclosure. For example, some of the operations depicted may be performed in parallel or in a different sequence that does not materially affect the function of the process. In other examples, different components of an example device or system that implements the process may perform functions at substantially the same time or in a specific sequence.

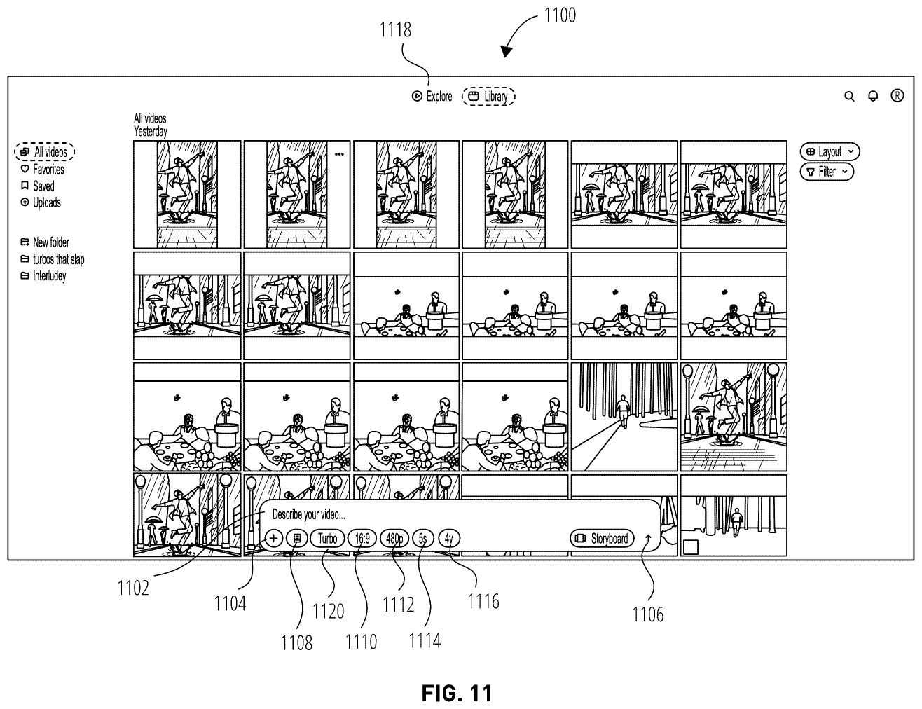

According to some examples, the method includes presenting a graphical user interface including a prompt editor at block 1002. For example, the front end 124 illustrated in FIG. 1 may present a graphical user interface including a prompt editor. FIG. 11 illustrates an example prompt editor 1102. Prompt editor 1102 can at least receive a text input, and in some embodiments, it can also receive one or more visual media as input. In some embodiments, prompt editor 1102 can also receive inputs effective to specify a resolution, an aspect ratio, and/or a length, of the desired visual media. In some embodiments, prompt editor 1102 can also receive time-based or frame-based inputs to provide detailed control of visual media that includes a sequence of frames over time.

According to some examples, the method includes receiving at least a text input into the prompt editor at block 1004. For example, the front end 124 illustrated in FIG. 1 may receive at least a text input into prompt editor 1102. The text input is a prompt that describes a visual media to be generated by a visual media generative response engine.

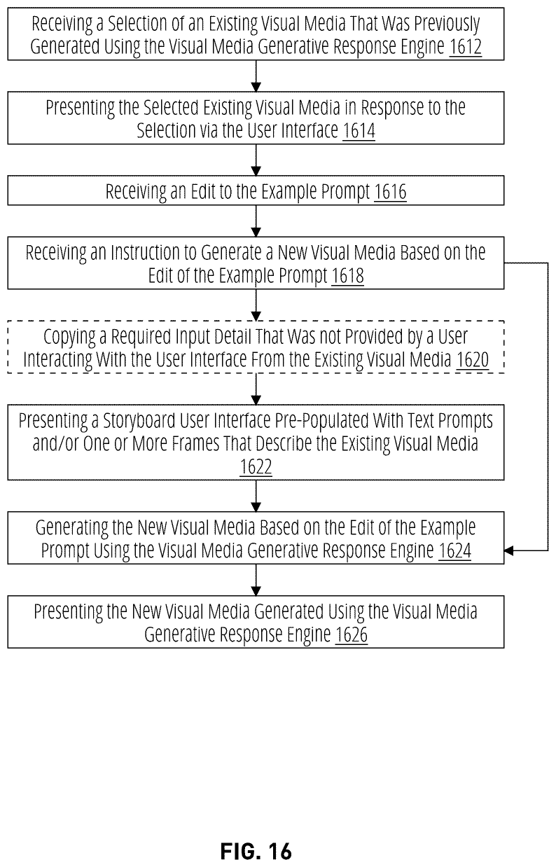

In some embodiments, prompt editor 1102 includes a visual media upload button 1104 that enables an input visual media to be included as part of the prompt. Visual media can also be added to the prompt by selecting the visual media from a gallery, as addressed in more detail with respect to FIG. 16.

According to some examples, the method includes receiving a command to generate visual media using at least one text input into the prompt editor at block 1006. For example, the front end 124 illustrated in FIG. 1 may receive a command to generate visual media using at least one text input into the prompt editor. The command can be received through a selection of the generate button 1106 illustrated in FIG. 11.

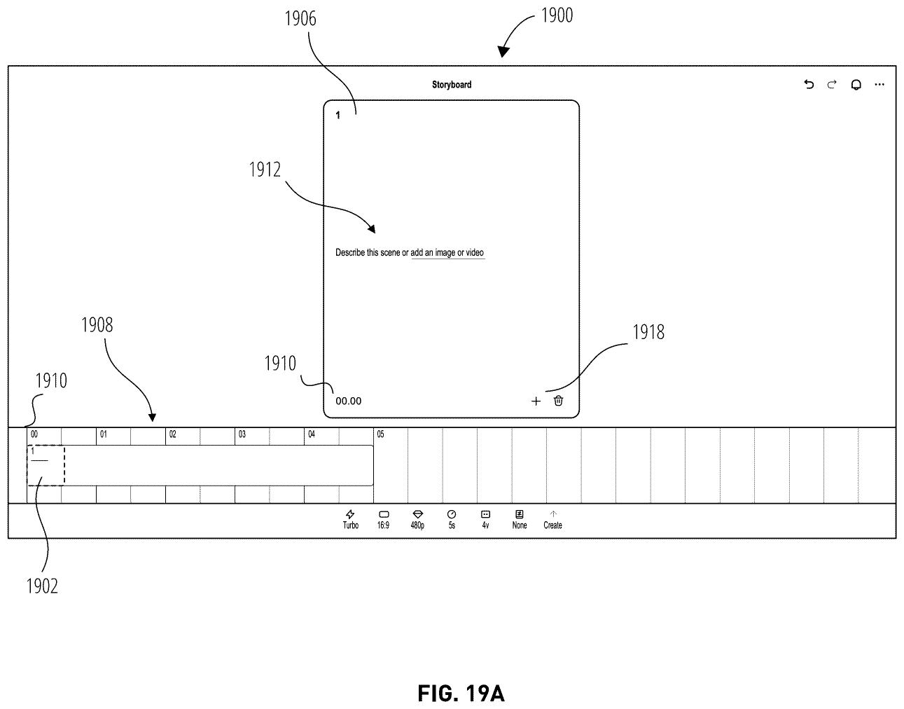

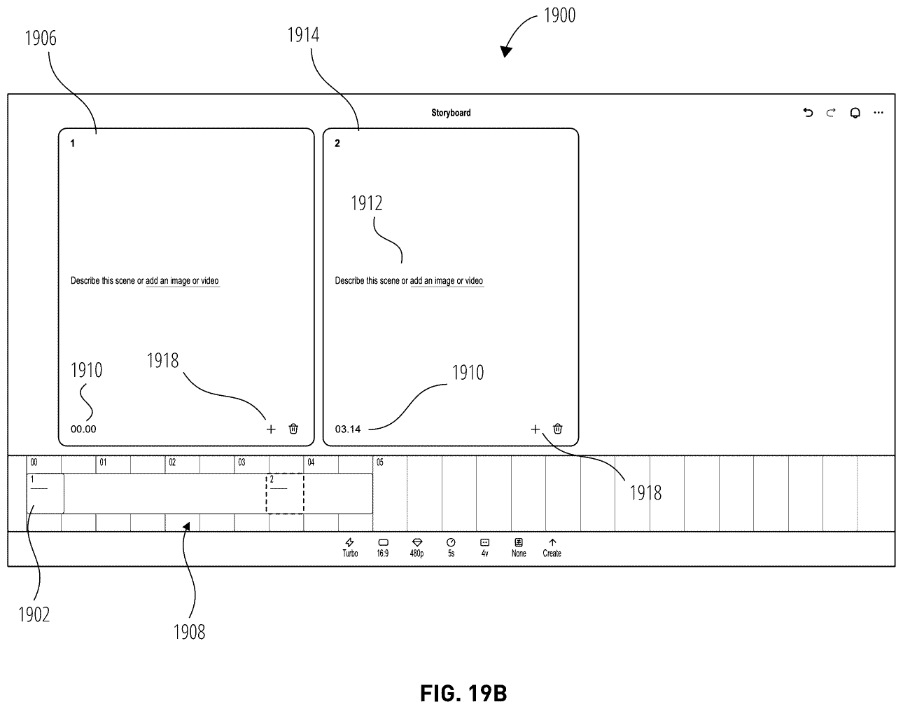

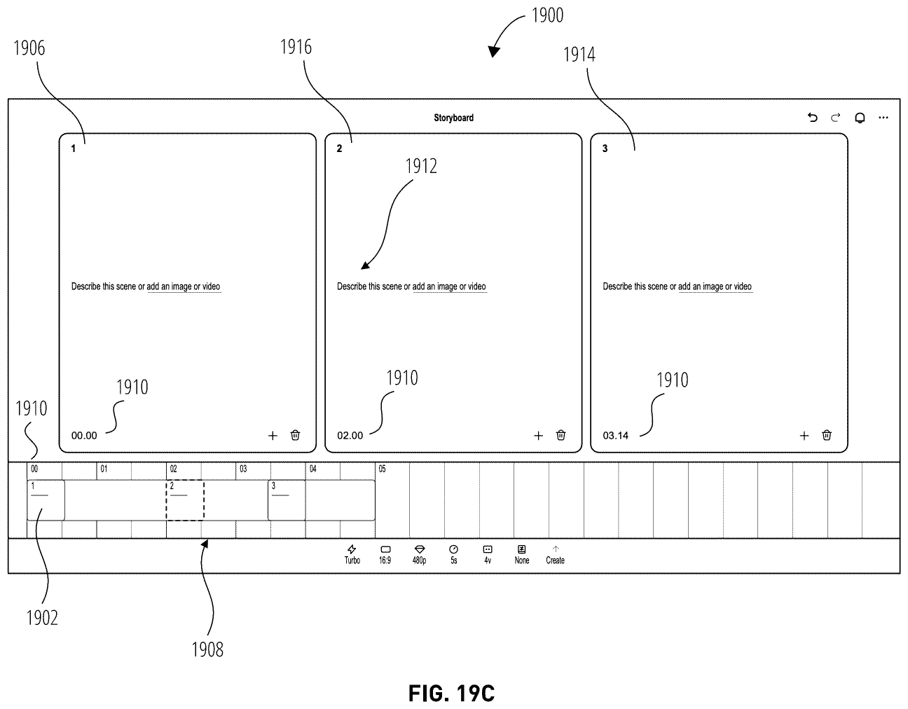

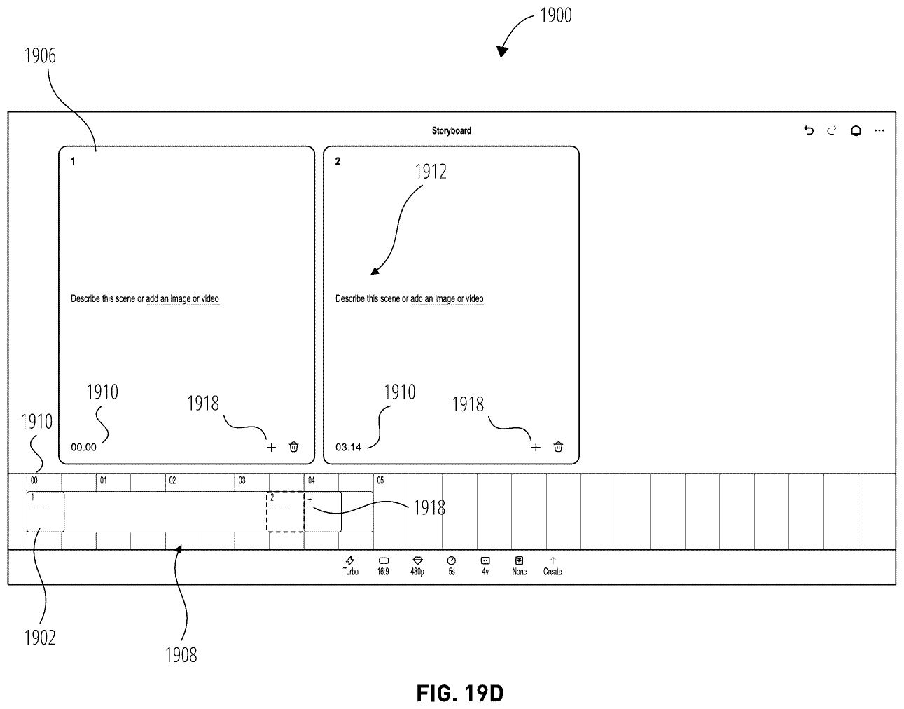

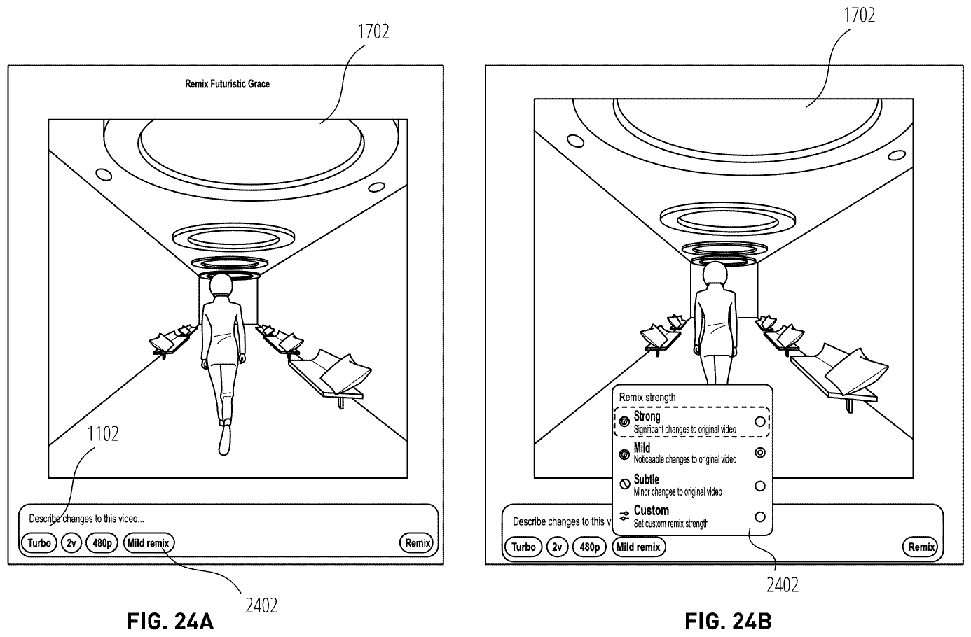

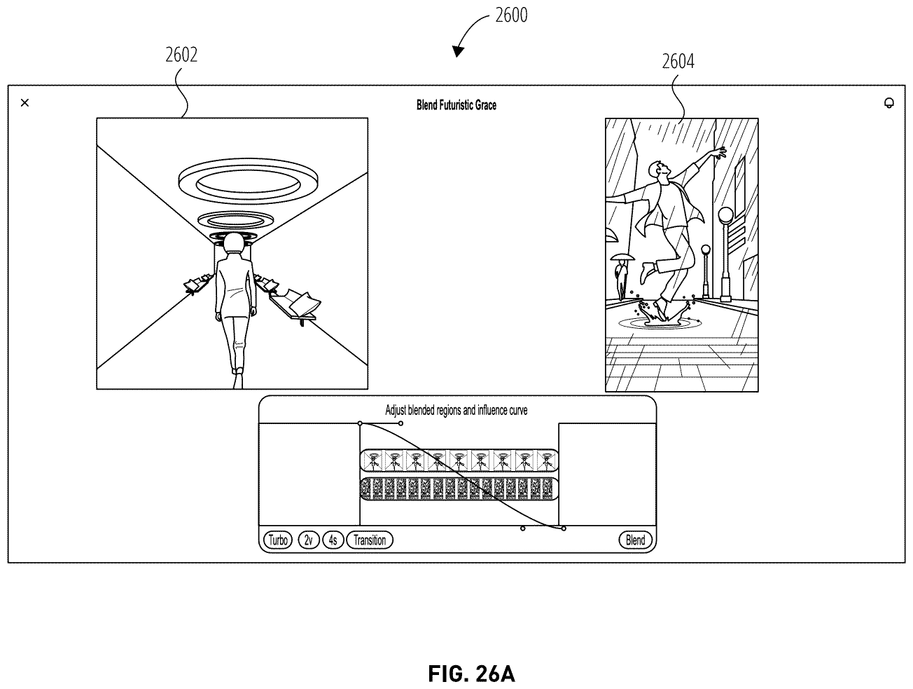

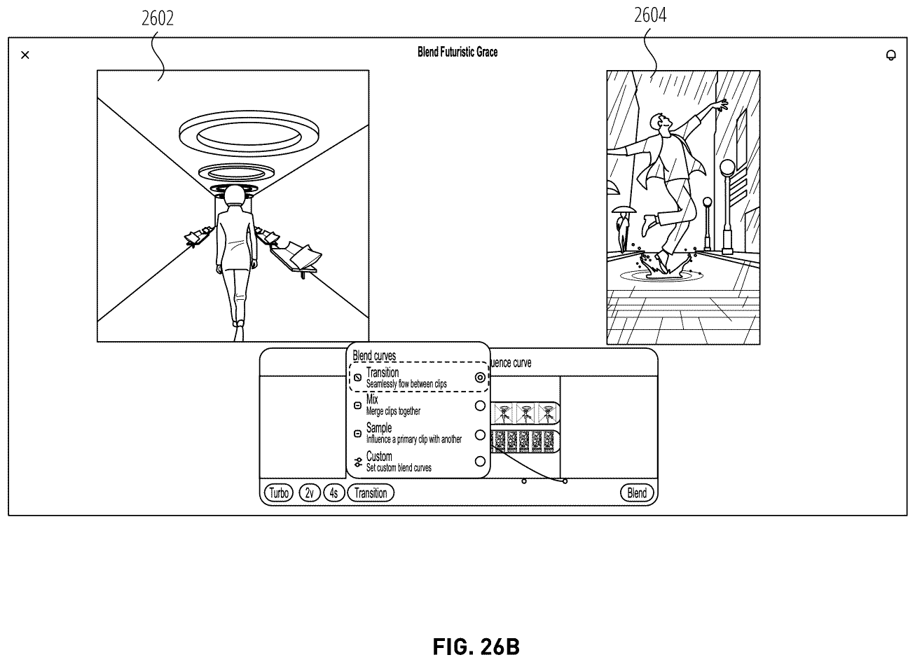

As will be addressed in greater detail with respect to at least FIG. 11, FIG. 19A-FIG. 19D, FIG. 24A-FIG. 24B, and FIG. 26A-FIG. 26B, other details can be provided to visual media generative response engine 100 as part of the prompt in addition to prompt text and/or visual media.

According to some examples, the method includes determining at least one of an aspect ratio or a resolution in which to generate the visual media at block 1008. For example, the front end 124 illustrated in FIG. 1 may determine at least one of an aspect ratio or a resolution in which to generate the visual media. As addressed herein, the visual media generative response engine is capable of generating visual media in multiple resolutions and/or aspect ratios. The resolution, aspect ratio, and duration of an output visual media are controlled through the attributes of the noisy frames that are provided to the diffusion-transformer layer of the visual media generative response engine. The diffusion-transformer layer will denoise the noisy frames to output frames in the same aspect ratio and resolution as the input noisy frames. The length of the video is controlled by the number of noisy frames and the frame rate at which the output frames are displayed. Accordingly, front end 124 can either determine an aspect ratio, resolution, and length based on the prompt using the aid of a deterministic algorithm or an artificial intelligence algorithm, or the user can explicitly indicate the desired aspect ratio, resolution, and/or length.

FIG. 11 illustrates examples of controls by which a user can provide explicit input for styles, aspect ratio, resolution, and/or length using style control 1108, aspect ratio input control 1110, resolution input control 1112, and/or duration input control 1114.

Style control 1108 allows the user to select and apply visual styles to the visual media to be generated.

Aspect ratio input control 1110 allows users to specify the width-to-height ratio of an image or video frame. Some common aspect ratios include 4:3 (Traditionally used in older television broadcasts and computer monitors), 16:9 (Widely adopted for high-definition TVs, modern video content, and computer displays as the standard widescreen format), 1.85:1 (Commonly used in cinema for theatrical releases, providing a slightly wider view than 16:9), 2.39:1 or 2.35:1 (Often used for widescreen films, also known as Cinemascope or Anamorphic format), 1:1 (Frequently used in social media platforms, such as Instagram, for square images and videos), and 21:9 (Found in ultra-widescreen monitors and some cinematic presentations, offering an immersive viewing experience).

Resolution input control 1112 enables users to set the desired pixel dimensions, which define the clarity and detail of the image or video. Common display resolutions include a range of pixel dimensions that cater to various devices and user needs. Starting with lower resolutions, 640×480 pixels, known as VGA, were once standard for early computer monitors. Moving up, 1024×768 pixels represents the XGA resolution, often used in older laptops and projectors. In the realm of high-definition, 1280×720 pixels define HD or 720p, primarily used in early HDTVs. Full HD, or 1080p, is characterized by 1920×1080 pixels and is prevalent in most modern televisions, computer monitors, and streaming services. For even higher clarity, 2560×1440 pixels, or QHD, provides a sharper experience, often found in gaming monitors. The 4K resolution, offering 3840×2160 pixels, is increasingly common in UHD TVs and high-end monitors. Finally, 8K resolution, with 7680×4320 pixels, delivers extremely high detail for cutting-edge displays, though it is still emerging in consumer markets. It is anticipated that higher resolutions will also become utilized in the future and will be compatible with the present technology.

Additionally, the duration input control 1114 permits users to define the duration or length of time for which visual content should be rendered. The length can be as short as zero seconds, which can result in a single frame being output as the visual media, or can be as long as desired. However, longer lengths might require longer processing times or scheduling of resources such that enough diffusion-transformer processing units can be available to process the number of frames required to generate the visual media. Currently, videos of up to one minute in length are easily accommodated using the techniques described herein with generally available cloud resources (GPUs in a data center). Longer videos are also possible through scheduling and scaling of the number of GPUs. Very long videos, such as feature-length films, might require additional optimizations, such as creating the video in segments and compressing frames into batches of 8 or 16 frames rather than the 4 addressed above.

In some embodiments, the user interface can also include model selector 1120, which can be used to select the visual media generative response engine to be used to generate the visual media. Some models can be smaller and faster, other models might be bigger and take longer to process, but might output better quality visual media.

In some embodiments, the graphical user interface can include number of generations input control 1116, wherein the number of generations input control 1116 is effective to cause the visual media generative response engine to generate more than one version of the output visual media. In this way, a user can select from several candidate visual media that all correspond to the prompt.

According to some examples, the method includes sending at least the text input, the aspect ratio, and the resolution in which to generate the visual media to the visual media generative response engine at block 1010. For example, front end 124 illustrated in FIG. 1 may send at least the text input, the aspect ratio, and the resolution in which to generate the visual media to the visual media generative response engine.

While FIG. 10 has thus far been addressed with respect to a graphical user interface that can configure a prompt and send the prompt to the visual media generative response engine, FIG. 10 also describes an embodiment wherein a third-party application might provide the graphical user interface, and the sending of the prompt at block 1010 is provided by an application programming interface (API).

According to some examples, the method includes receiving the visual media generated based on the prompt at block 1012. For example, the front end 124 illustrated in FIG. 1 may receive the visual media generated based on the prompt. The visual media was generated in the aspect ratio or the resolution that was provided with the prompt. In some embodiments, front end 124 can include a viewer or player that can display the visual media.

FIG. 11 illustrates an example library interface 1100 in accordance with some embodiments of the present technology. While FIG. 11 illustrates a particular user interface, the present technology should not be considered limited to use with such an interface. Rather, the user interface illustrated in FIG. 11 is provided to illustrate example options and example functionality provided by the present technology.

Library interface 1100 presents a library of visual media saved by a user account. The visual media can be visual media created by the user account, or visual media created by other user accounts and saved by the user account. As will be explained herein, any of the visual media in the user account library can be used to create new visual media.

Library interface 1100 also includes an explore tab 1118 user interface object that directs to a public library of previously generated visual media. While not shown, the public library can be a rotating selection of visual media created by other user accounts. These visual media can provide inspiration and starting points for the creation of new visual media.

As addressed above, library interface 1100 also includes prompt editor 1102 for creating and adjusting prompts for use in generating visual media using visual media generative response engine 100.

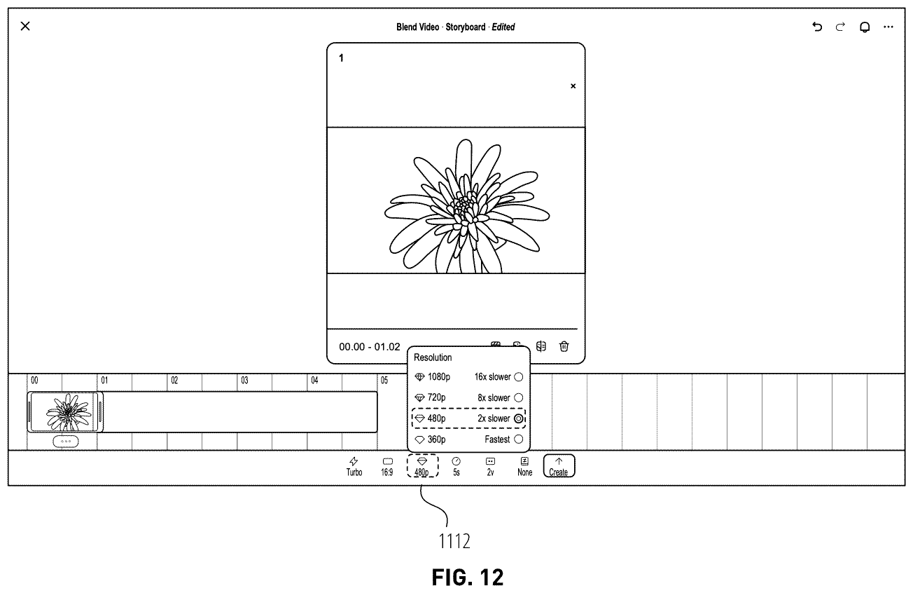

FIG. 12 illustrates a resolution input control menu in accordance with some embodiments of the present technology. As shown in FIG. 12, resolution input control 1112 includes options to select from 360p, 480p, 720p, and 1080p resolutions. While these are the only resolutions listed in resolution input control 1112, the present technology is capable of providing other resolutions, though processing time will be adjusted proportionately. The user interface also informs the user of the added processing time that higher resolutions will add to the generation of the visual media.

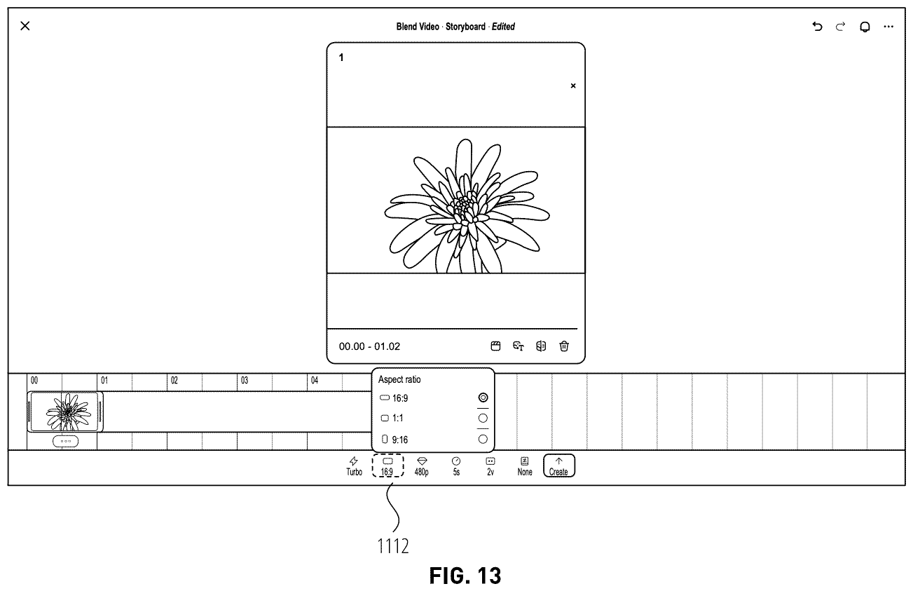

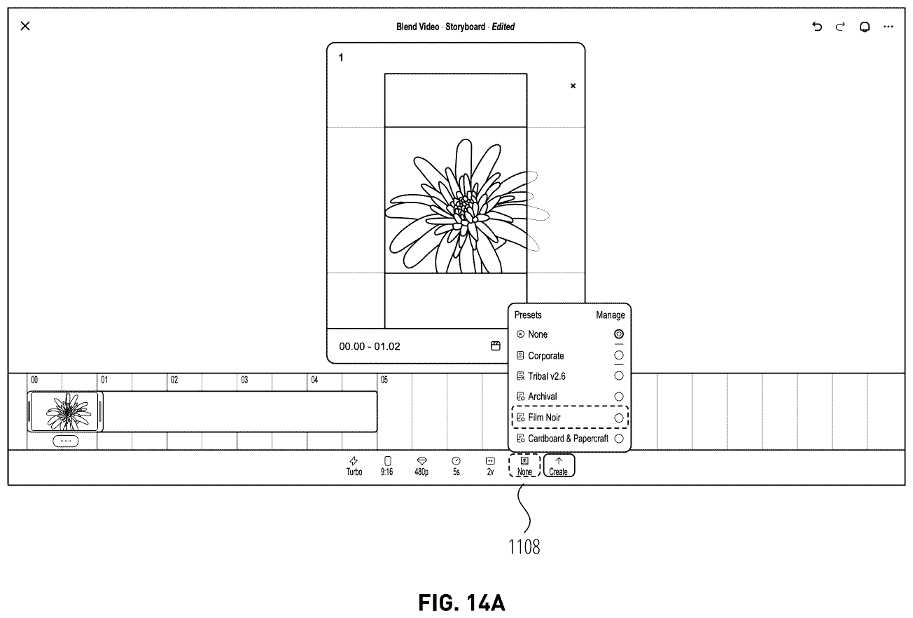

FIG. 13 illustrates an aspect ratio input control menu in accordance with some embodiments of the present technology. As shown in FIG. 13, aspect ratio input control 1110 includes options to select from aspect ratios of 16:9, 1:1, and 9:16. While these are the only aspect ratios listed in aspect ratio input control 1110, the present technology is capable of providing other aspect ratios when it is provided with noisy frames of the same aspect ratio.

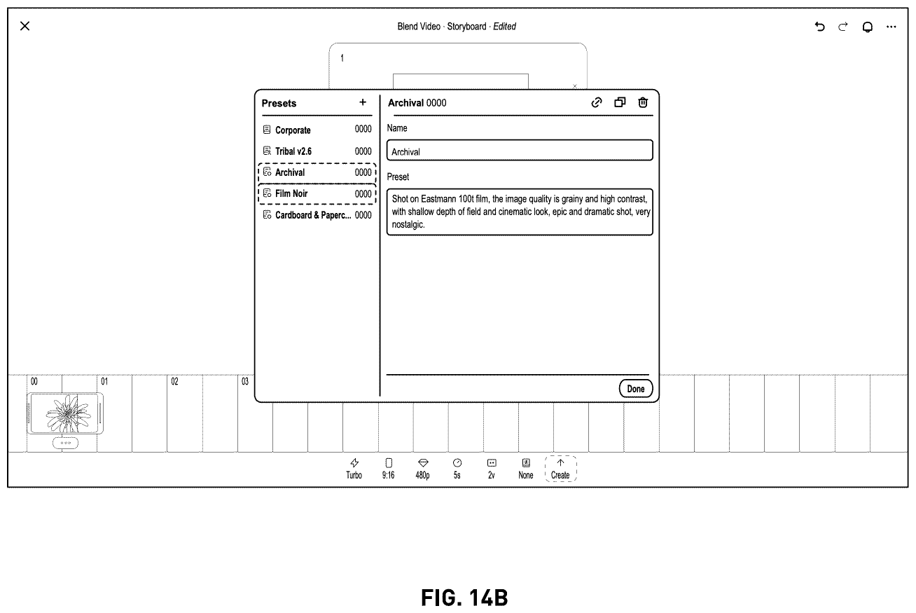

FIG. 14A and FIG. 14B illustrates a style control menu and configuration interface in accordance with some embodiments of the present technology.

FIG. 14A illustrates style control 1108 menu to select from preset style options. In some embodiments, the preset style options are pre-configured as part of the user interface. In some embodiments, the preset style options are those that have been previously configured by the user account.

FIG. 14B illustrates a style configuration interface. For example, FIG. 14B illustrates a description of the archival preset style. Behind a preset style is text that describes the style. In some embodiments, the style acts like a system prompt in that the user does not see the text describing the style added to their prompt in a prompt editor or storyboard user interface, but the text describing the style is added by the front end before sending the prompt to the next layer of the visual media generative response engine.

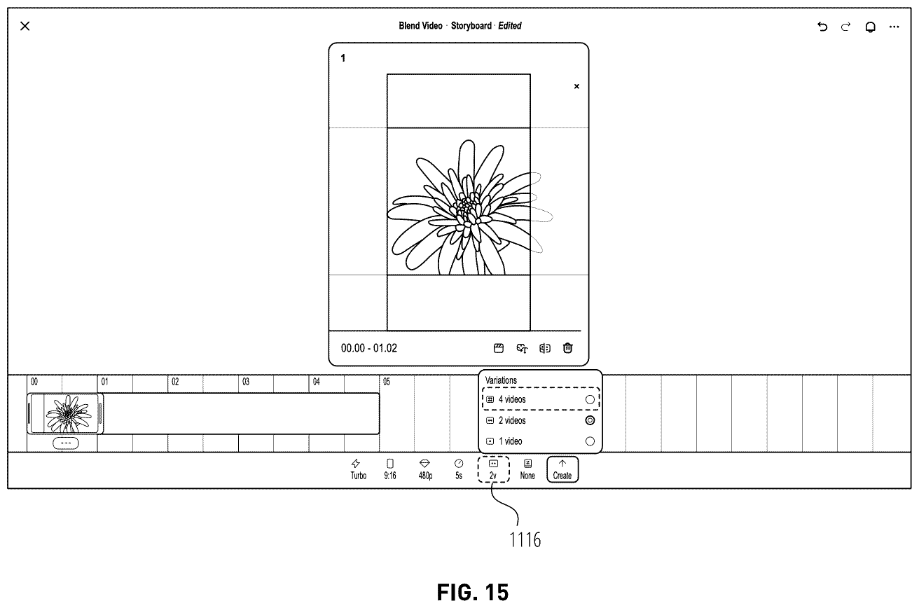

FIG. 15 illustrates a number of generations input control in accordance with some embodiments of the present technology. As shown in FIG. 15, number of generations input control 1116 includes options to generate 1, 2, or 4 variations of visual media responsive to the prompt. In this way, a user can select from several candidate visual media that all correspond to the prompt.

FIG. 16 illustrates an example process for creating new visual media from existing visual media prompts in accordance with some embodiments of the present technology. Although the example process depicts a particular sequence of operations, the sequence may be altered without departing from the scope of the present disclosure. For example, some of the operations depicted may be performed in parallel or in a different sequence that does not materially affect the function of the process. In other examples, different components of an example device or system that implements the process may perform functions at substantially the same time or in a specific sequence.

According to some examples, the method includes receiving a selection of existing visual media that was previously generated using the visual media generative response engine at block 1612. For example, the user interface provided by front end 124 illustrated in FIG. 1 may receive a selection of existing visual media that was previously generated using the visual media generative response engine. The existing visual media can be presented in a public gallery or a private library.

According to some examples, the method includes presenting the selected existing visual media in response to the selection via the user interface at block 1614. For example, the user interface provided by front end 124 illustrated in FIG. 1 may present the selected existing visual media in response to the selection via the user interface.

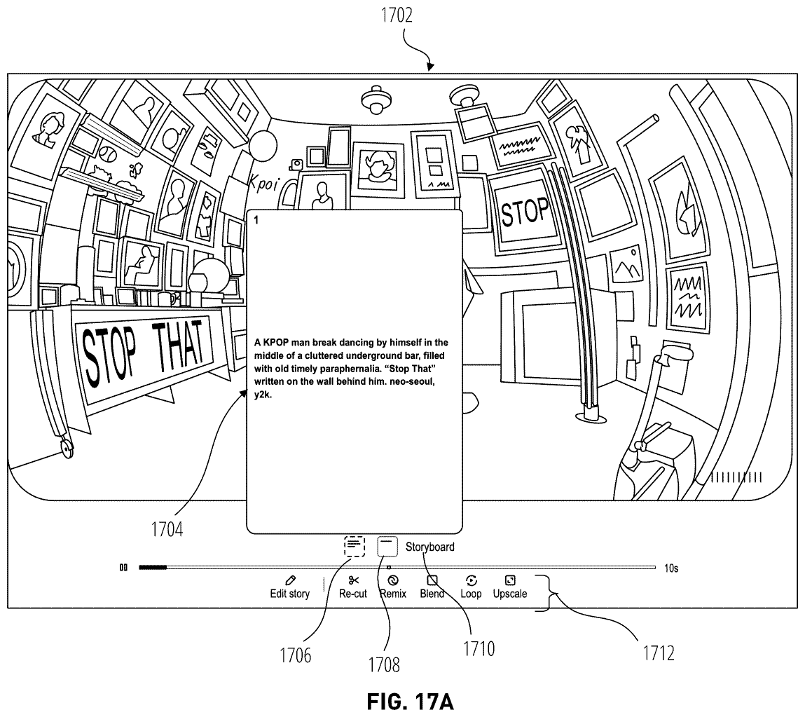

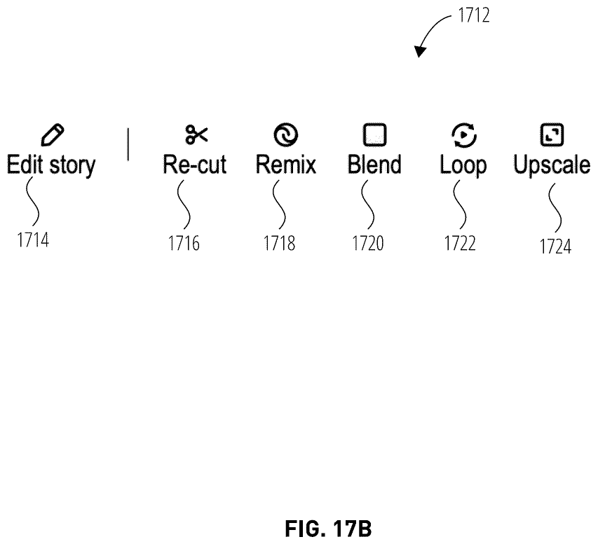

For example, FIG. 17A shows a frame of an existing visual media 1702 selected from a public gallery. Selected existing visual media 1702 is presented with a prompt for the existing visual media 1704. The prompt for the existing visual media 1704 is the prompt used to create the visual media, which is displayed in response to a selection of the display prompt for the visual media 1706 option. In some embodiments, a user can select a display prompt for this frame of the visual media 1708 option, which causes the user interface to display a machine-generated description of a particular frame of the visual media.

According to some examples, the method includes receiving an edit to the example prompt at block 1616. For example, the user interface provided by front end 124 illustrated in FIG. 1 may receive an edit to the example prompt. Whether the prompt for the visual media or the prompt for a frame of the visual media, the prompt can be used to create a new visual media by adapting or refining the prompt.

According to some examples, the method includes receiving an instruction to generate a new visual media based on the edit of the example prompt at block 1618. For example, the user interface provided by front end 124 illustrated in FIG. 1 may receive an instruction to generate a new visual media based on the edit of the example prompt.

According to some examples, the method includes copying a required input detail that was not provided by a user interacting with the user interface from the existing visual media at block 1620. For example, the user interface provided by front end 124 illustrated in FIG. 1 may copy a required input detail that was not provided by a user interacting with the user interface from the existing visual media. In some instances, a user might neglect to specify a desired output resolution, duration, aspect ratio, etc. In such instances, the present technology can import any input details that were not specified by the user from the visual media that is the inspiration for the new visual media to be generated.

According to some examples, the method includes presenting a storyboard user interface pre-populated with text prompts and/or one or more frames that describe the existing visual media at block 1622. For example, the user interface provided by front end 124 illustrated in FIG. 1 may present a storyboard user interface pre-populated with text prompts and/or one or more frames that describe the existing visual media. FIG. 17A illustrates display storyboard for the visual media 1710 option, which can result in a display of a storyboard that can facilitate more control over the generation of the video. The storyboard user interface will be addressed in greater detail with respect to at least FIG. 19A-FIG. 19D.

According to some examples, the method includes generating the new visual media based on the edit of the example prompt using the visual media generative response engine at block 1624. For example, the visual media generative response engine 100 illustrated in FIG. 1 may generate the new visual media based on the edit of the example prompt using the visual media generative response engine.

According to some examples, the method includes presenting the new visual media generated using the visual media generative response engine at block 1626. For example, the user interface provided by front end 124 illustrated in FIG. 1 may present the new visual media generated using the visual media generative response engine.

FIG. 17A illustrates an example frame from a previously created visual media in accordance with some embodiments of the present technology. While FIG. 17A illustrates a particular user interface, the present technology should not be considered limited to use with such an interface. Rather, the user interface illustrated in FIG. 17A is provided to illustrate example options and example functionality provided by the present technology.

In particular, FIG. 17A illustrates existing visual media 1702 along with the prompt for the existing visual media 1704 used to create the video responsive to the prompt.

FIG. 17A also displays an option to display prompt for the visual media 1706, display prompt for this frame of the visual media 1708, and display storyboard for the visual media 1710 as addressed above. FIG. 17A also provides editing options 1712, which are addressed in FIG. 17B.

FIG. 17B illustrates editing options in accordance with some embodiments of the present technology. FIG. 17B is a closer view of the editing options 1712 illustrated in FIG. 17A.

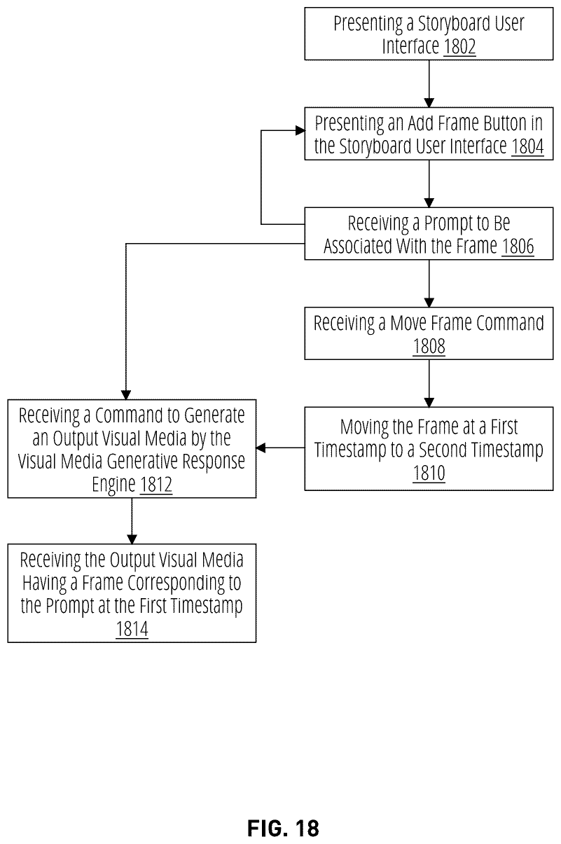

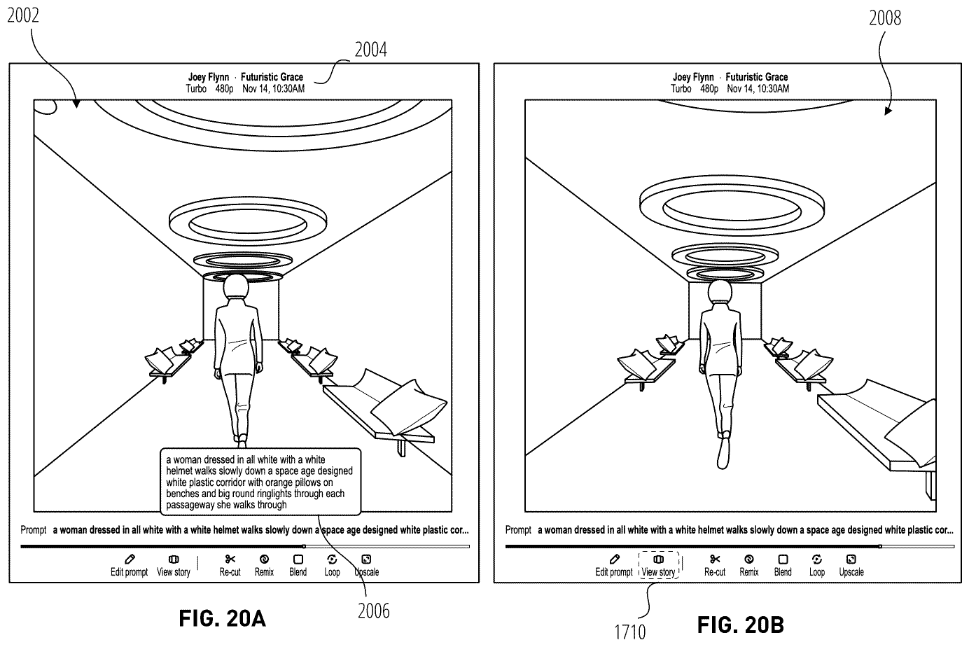

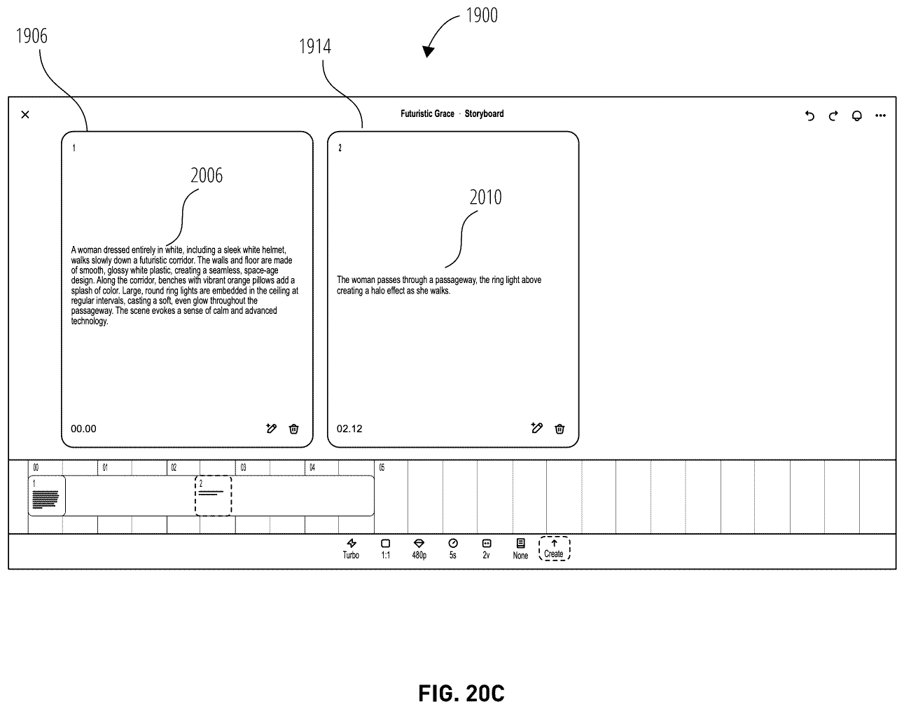

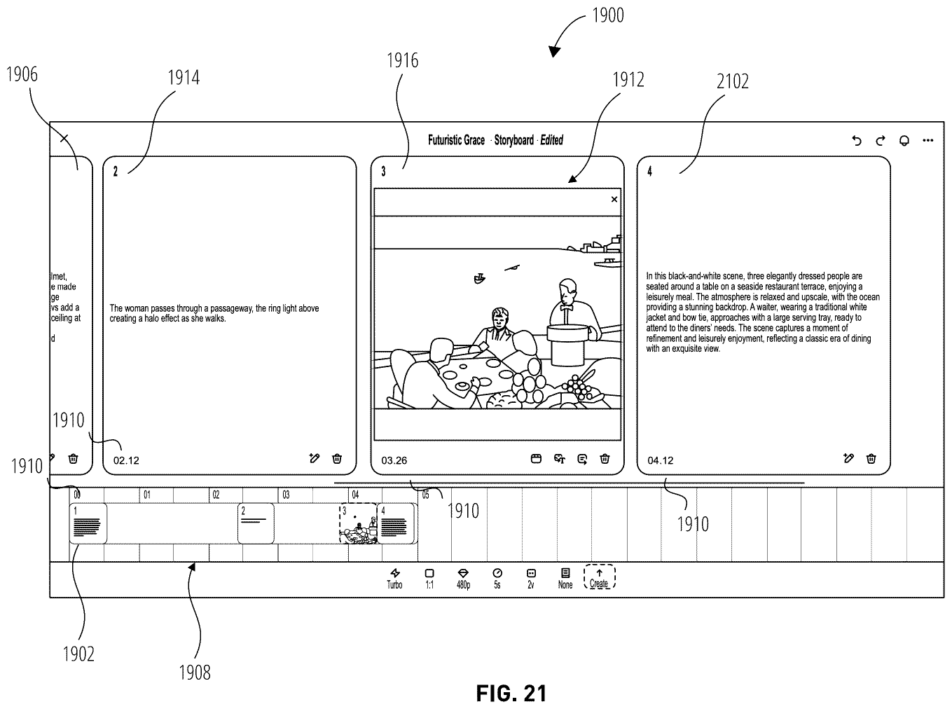

One of editing options 1712 is storyboard user interface button 1714, which is used to launch a storyboard user interface. The storyboard user interface is addressed in greater detail with respect to FIG. 18, FIG. 19A-FIG. 19D, FIG. 20C, and FIG. 21.

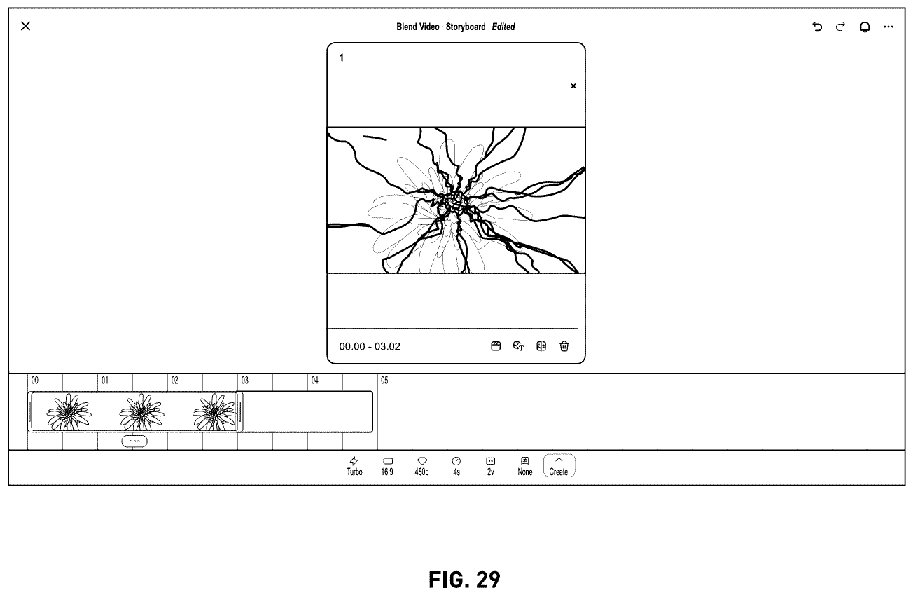

Another of editing options 1712 is trim frames interface button 1716, which is used to launch an interface to crop frames from generated visual media. Such an interface is illustrated in FIG. 29.

Another of editing options 1712 is remix interface button 1718, which is used to change up an editing visual media. Such an interface is illustrated in FIG. 24A and FIG. 24B.

Another of editing options 1712 is blending interface button 1720, which is used to to blend a first provided visual media with another visual media or with a text prompt. Such an interface is illustrated in FIG. 26A and FIG. 26B.

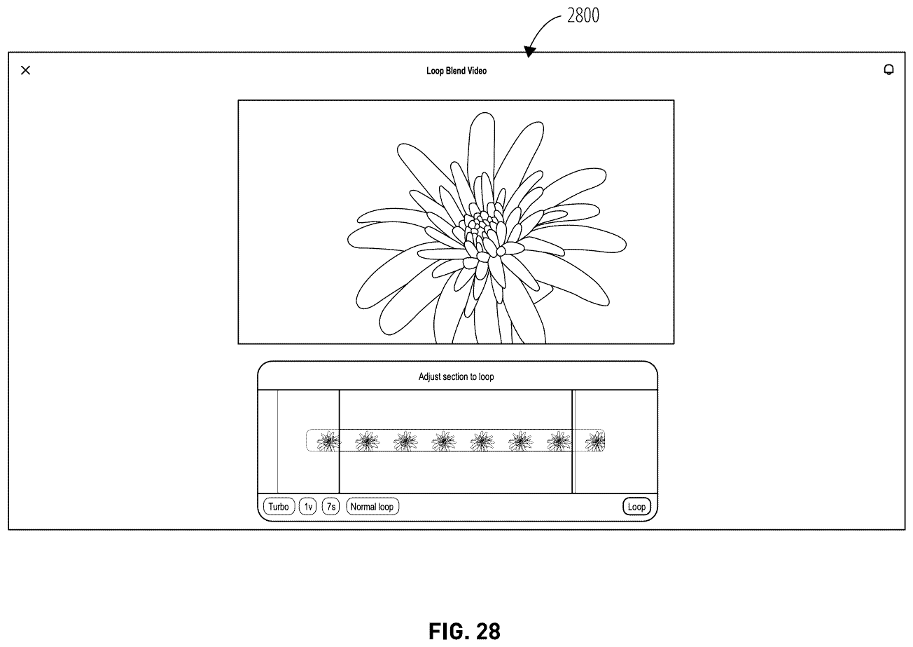

Another of editing options 1712 is loop interface button 1722, which is used to loop the visual media so the visual media can play continuously without a viewer appreciating a beginning or an end of the visual media. Such an interface is illustrated in FIG. 28.

Another of editing options 1712 is upscale resolution button 1724, which can be used to upscale the visual media to a higher resolution. This can be useful when a visual artist wants faster generations from the visual media generative response engine so that the visual artist can iterate towards generating a draft visual media and only generate a high-resolution version once the visual artist has achieved a lower-resolution version of their artistic vision.

FIG. 18 illustrates an example process for aiding a user in generating a prompt to a visual media generative response engine through a storyboard user interface in accordance with some embodiments of the present technology. Although the example process depicts a particular sequence of operations, the sequence may be altered without departing from the scope of the present disclosure. For example, some of the operations depicted may be performed in parallel or in a different sequence that does not materially affect the function of the process. In other examples, different components of an example device or system that implements the process may perform functions at substantially the same time or in a specific sequence.

As videos include a series of frames displayed over time, the creation of a video often involves planning transitions between frames or scenes such that when the frames are played in series, they portray a visual story. In some embodiments, a user can articulate that story in a single long prompt, but the timing of various story elements and transitions are a little bit unpredictable when the visual media generative response engine is given a single text prompt. Accordingly, the present technology provides a storyboard user interface that allows a user to provide visual or textual prompts for frames to occur at particular time points in the video. In this way, a visual artist can exert additional control over the progression of the visual media to be generated by visual media generative response engine 100.

According to some examples, the method includes presenting a storyboard user interface at block 1802. For example, the front end 124 illustrated in FIG. 1 may present a storyboard user interface. The storyboard user interface includes a visual media timeline and a representation of a first frame located on the visual media timeline. FIG. 19A-FIG. 19D illustrates examples of the storyboard user interface 1900. As illustrated in FIG. 19A, storyboard user interface 1900 includes timescale 1908 representing the duration of the video to be generated. One or more frames can be added on timescale 1908, for example, first frame 1906 in FIG. 19A.

According to some examples, the method includes presenting an add frame option in the storyboard user interface at block 1804. For example, the front end 124 illustrated in FIG. 1 may present an add frame option in the storyboard user interface. The add frame button is effective to cause a representation of a second frame to be presented on the visual media timeline. FIG. 19A illustrates add frame option 1918, which is effective to add second frame 1914 as illustrated in FIG. 19B.

According to some examples, the method includes receiving a prompt to be associated with the frame at block 1806. For example, the front end 124 illustrated in FIG. 1 may receive a prompt to be associated with the frame. The prompt can include text or visual media. FIG. 19A illustrates an example of prompt editor 1912 for first frame 1906. A completed prompt describing the visual media 2006 is illustrated in FIG. 20A and FIG. 20C.

In some embodiments, several frames can be added and associated with respective prompts. For example, FIG. 20C shows first frame 1906 with prompt describing the visual media 2006 and second frame 1914 with prompt describing another frame of the existing visual media 2010. While the examples illustrate text prompts, the prompts can be visual prompts, too. FIG. 21 illustrates an example of third frame 1916 including a visual prompt.

According to some examples, the method includes receiving a move frame command at block 1808. For example, the front end 124 illustrated in FIG. 1 may receive a move frame command. In some embodiments, the user can operate a user interface device to drag a frame to a new location on timescale 1908. In response to the command to move the frame, the method includes moving the frame originally located at the first timestamp to a second timestamp at block 1810.

According to some examples, the method includes receiving a command to generate an output visual media by the visual media generative response engine at block 1812. For example, the visual media generative response engine 100 illustrated in FIG. 1 may receive a command to generate an output visual media by the visual media generative response engine. The prompt associated with at least the first frame is provided to the visual media generative response engine along with a first timestamp indicating that the prompt describes a desired output first frame at the first timestamp. The prompts associated with second and third frames, etc., can also be provided to visual media generative response engine 100 with their respective timestamps as well.

According to some examples, the method includes receiving the output visual media having a frame corresponding to at least the prompt at the first timestamp at block 1814. For example, the front end 124 illustrated in FIG. 1 may receive the output visual media having a frame corresponding to the prompt at the first timestamp, and if provided, the prompt at the second timestamp and prompt at the third timestamp, etc. As addressed above, the present technology can utilize embeddings to represent text or images and can provide the embeddings interleaved with noisy frames so that the diffusion-transformer layer can refine the noisy frames into finished frames that are consistent with the embeddings. In this way, the present technology can utilize prompts provided in the storyboard user interface to generate the output visual media.

FIG. 19A, FIG. 19B, FIG. 19C, and FIG. 19D illustrates aspects of a storyboard user interface in accordance with some embodiments of the present technology. While FIG. 19A-FIG. 19D illustrates a particular user interface, the present technology should not be considered limited to use with such an interface. Rather, the user interface illustrated in FIG. 19A-FIG. 19D is provided to illustrate example options and example functionality provided by the present technology.

FIG. 19A illustrates a blank storyboard user interface 1900. Storyboard user interface 1900 includes first frame 1906, which is also represented along timescale 1908 as first frame thumbnail 1902. First frame 1906 includes timestamp 1910, showing that the frame occurs at 0-seconds, and first frame thumbnail 1902 is located at the 0-second location on timescale 1908.

First frame 1906 is represented in the middle of storyboard user interface 1900, which can indicate that first frame 1906 is the frame that is in focus for editing via prompt editor 1912.

One or more additional frames can be added using add frame option 1918.

FIG. 19B illustrates a blank storyboard user interface 1900 having two frames. First frame 1906 is at timestamp 0-seconds, and second frame 1914 is at timestamp 3.14-seconds. Since second frame 1914 is in the center of storyboard user interface 1900 it is considered in focus for editing, and a prompt for second frame 1914 can be entered using prompt editor 1912. The prompt can be text or visual media.

FIG. 19C illustrates a blank storyboard user interface 1900 having three prompt frames. First frame 1906 is at timestamp 0-seconds, second frame 1914 is at timestamp 3.14-seconds, and third frame 1916 has been added at timestamp 2-seconds. Since third frame 1916 is in the center of storyboard user interface 1900 it is considered in focus for editing, and a prompt for second frame 1914 can be entered using prompt editor 1912. The prompt can be text or visual media.

FIG. 19D illustrates a blank storyboard user interface 1900 having two frames. FIG. 19D is similar to FIG. 19B, but illustrates another version of add frame option 1918. FIG. 19D illustrates that add frame option 1918 can appear when a user interface hovers over a frame on timescale 1908. A selection of add frame option 1918 on timescale 1908 can result in a new frame being added at that timestamp. Additionally, a frame located at a timestamp can be dragged to a new timestamp as desired.

FIG. 20A, FIG. 20B, and FIG. 20C illustrates an example of a generated video and a populated storyboard user interface corresponding to the generated video in accordance with some embodiments of the present technology. While FIG. 20A-FIG. 20C illustrates particular user interface, the present technology should not be considered limited to use with such an interface. Rather, the user interface illustrated in FIG. 20A-FIG. 20C is provided to illustrate example options and example functionality provided by the present technology.

FIG. 20A illustrates a visual media viewing interface playing an existing visual media. The existing visual media could have been selected from a public gallery or a library of content created or shared with the user account of the user interacting with the visual media viewing interface. In particular, a frame of existing visual media 2002 is illustrated along with biographic information 2004 for the existing visual media. Below the frame of existing visual media 2002, a user has clicked on a snippet of text showing a portion of the prompt used to create the existing visual media, which has resulted in a display of a prompt describing the visual media 2006.

FIG. 20B illustrates the visual media viewing interface playing the existing visual media, and displaying another frame of the existing visual media 2008. This is a frame later in the visual media than frame of existing visual media 2002 as it is apparent the woman has walked further down the hall when using the overhead ring lights as a reference point.

FIG. 20B also illustrates an user interface control, a pointer, over display storyboard for the visual media 1710 option.

FIG. 20C illustrates storyboard user interface 1900 that results after the visual media viewing interface has received a selection of display storyboard for the visual media 1710 option. In the location of first frame 1906 is prompt describing the visual media 2006. Note that this prompt is descriptive of the entire visual media, not just the first frame. In the location of second frame 1914 is a prompt describing another frame of the existing visual media 2010. Note that although, this description calls frames a first frame, second frame, third frame, etc. This is only to distinguish the frames from one another, and by calling a frame a first, second, or third frame does not imply that the frame is the first, second, or third frame of the visual media.

The timestamp of second frame 1914 is 2.12 seconds, and the prompt is “The woman passes through a passageway, the ring light above creating a halo effect as she walks.” The effect of this prompt is to guide the visual media generative response engine to generate frames generally corresponding to this description around this timestamp in the video.

The storyboard user interface does not always need to just advance a plot or a visual story at the right pace. In some embodiments, the storyboard user interface is particularly effective at causing significant changes to occur.

FIG. 21 illustrates an example of using the storyboard user interface to transition a visual media into a different scene in accordance with some embodiments of the present technology. FIG. 21 also illustrates that a prompt can be a visual prompt. While FIG. 21 illustrates a particular user interface, the present technology should not be considered limited to use with such an interface. Rather, the user interface illustrated in FIG. 21 is provided to illustrate example options and example functionality provided by the present technology.

To the left, FIG. 21 illustrates storyboard user interface 1900 with first frame 1906 and second frame 1914 of the visual media of the woman walking down the futuristic corridor illustrated in FIG. 20A-FIG. 20C. Third frame 1916 is a frame of visual media set in an entirely different scene, and fourth frame 2102 is a prompt describing the visual media in the third frame.

If the prompts included in this storyboard user interface were to be submitted to the visual media generative response engine, the text and visual prompts would be embedded. The embeddings would be inserted between noisy frames and provided to the diffusion-transformer layer. The diffusion-transformer layer would attempt to denoise the noisy frames into frames that are consistent with the embeddings. The result might start with the scene of the woman walking through the futuristic hallway, and at the end of the hallway, the woman might walk into the scene of the people eating dinner next to the ocean. Or the result might start with the woman walking down a futuristic hallway with some people in the scene gathered in the hallway and progressing to everyone meeting at a table in the futuristic environment. In fact, every time the visual media is generated a new result would be created.

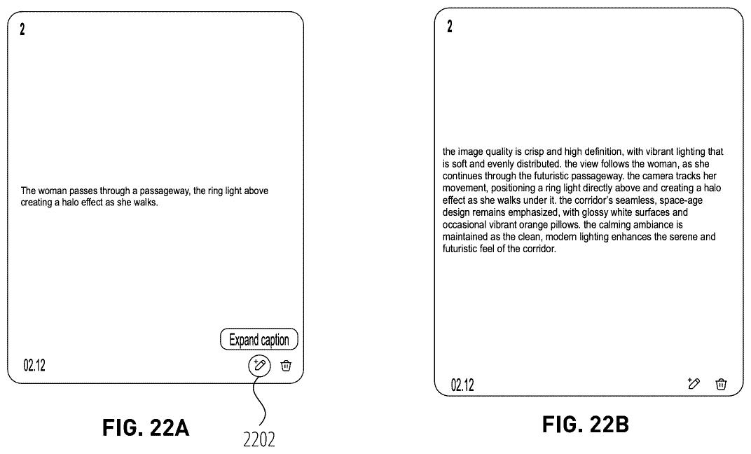

FIG. 22A and FIG. 22B illustrates an example of enhancing a prompt to be more descriptive in accordance with some embodiments of the present technology. While FIG. 22A and FIG. 22B illustrates a particular user interface, the present technology should not be considered limited to use with such an interface. Rather, the user interface illustrated in FIG. 22A and FIG. 22B is provided to illustrate example options and example functionality provided by the present technology.

FIG. 22A illustrates an example one-sentence prompt. A user interface pointer is positioned over prompt enhancement option 2202. FIG. 22B illustrates a prompt that results from the selection of prompt enhancement option 2202. After the user interface received the selection of prompt enhancement option 2202, the one-sentence prompt from FIG. 22A was sent to a language model to be enhanced with greater detail, and that is more useful in guiding the output of a visual media generative response engine.

The graphical user interface includes a prompt enhancement option 2202, which, when selected, is effective to input the prompt to a language model to generate an enhanced prompt and to replace the prompt with the enhanced prompt in the prompt editor. Prompt enhancement option 2202 can be useful because users, especially novice users, often provide high-level prompts that leave many details to be inferred. Prompt enhancement option 2202 can receive a more detailed prompt from a language model, where the more detailed prompt is explicit about many additional details. The user interacting with prompt editor 1102 can then review the detailed prompt and either accept the detailed prompt, or edit details that are not part of the user's vision for the output visual media.

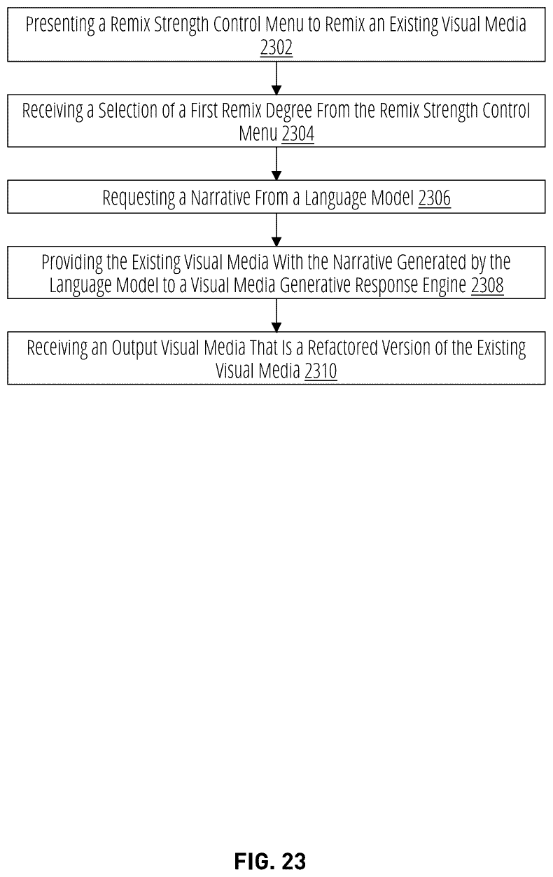

FIG. 23 illustrates an example process for inducing a visual media generative response engine to refactor an existing visual media in accordance with some embodiments of the present technology. Although the example process depicts a particular sequence of operations, the sequence may be altered without departing from the scope of the present disclosure. For example, some of the operations depicted may be performed in parallel or in a different sequence that does not materially affect the function of the process. In other examples, different components of an example device or system that implements the process may perform functions at substantially the same time or in a specific sequence.

As addressed above, the present technology provides access to a gallery of existing visual media to give inspiration to other visual artists to create new visual media using the existing visual media as inspiration or a starting point. FIG. 24A illustrates an interface that displays an example of existing visual media, and that includes prompt editor 1102 to create a text prompt that describes a desired new visual media to be created using the existing visual media as inspiration.

According to some examples, the method includes presenting a remix strength control menu to remix the existing visual media at block 2302. For example, the front end 124 illustrated in FIG. 1 may present a remix strength control menu to remix an existing visual media. The remix strength control menu includes options for remix degrees for refactoring the existing visual media. FIG. 24A and FIG. 24B illustrates remix strength control menu 2402.

According to some examples, the method includes receiving a selection of a first remix degree from the remix strength control menu at block 2304. For example, the front end 124 illustrated in FIG. 1 may receive a selection of a first remix degree from the remix strength control menu. For example, as illustrated in FIG. 24B remix degrees can be selected from strong, mild, subtle, and custom.

The remix strength can be controlled by modified prompts, as depicted in block 2306 and block 2308, or through adjusting characteristics such as the amount of noise provided in the input visual media or a combination of the two.

According to some examples, the method includes requesting a narrative from a language model at block 2306. For example, the front end 124 illustrated in FIG. 1 may request a narrative from a language model. A prompt to the language model includes the existing visual media or a text caption of the existing visual media with an instruction to generate the narrative based on the existing visual media but varied according to the first remix degree.

According to some examples, the method includes providing the existing visual media with the narrative generated by the language model to a visual media generative response engine at block 2308. For example, the front end 124 illustrated in FIG. 1 may provide the existing visual media with the narrative generated by the language model to a visual media generative response engine.

As introduced above, another way of controlling the remix strength is to adjust the amount of noise provided with an input visual media. For example, when an input frame is to be an input to the visual media generative response engine, the amount of noise in that frame can be adjusted. Generally, when an input frame is encoded and provided as an input to the visual media generative response engine, the input frame is provided without noise, along with a collection of noisy frames that are refined to produce the visual media. But when a remix level is selected from the remix strength control menu, the input frame can include some amount of introduced noise. A low remix strength (“subtle” in the drawing) can be associated with a little noise, whereas a high remix strength (“strong” in the drawing) can be associated with a significant amount of noise. The more noise in the input frame, the more susceptible the frame is to changes introduced by the visual media generative response engine.

According to some examples, the method includes receiving an output visual media that is a refactored version of the existing visual media at block 2310. For example, the front end 124 illustrated in FIG. 1 may receive an output visual media that is a refactored version of the existing visual media. The amount of refactoring of the existing visual media was controlled by the first remix degree.

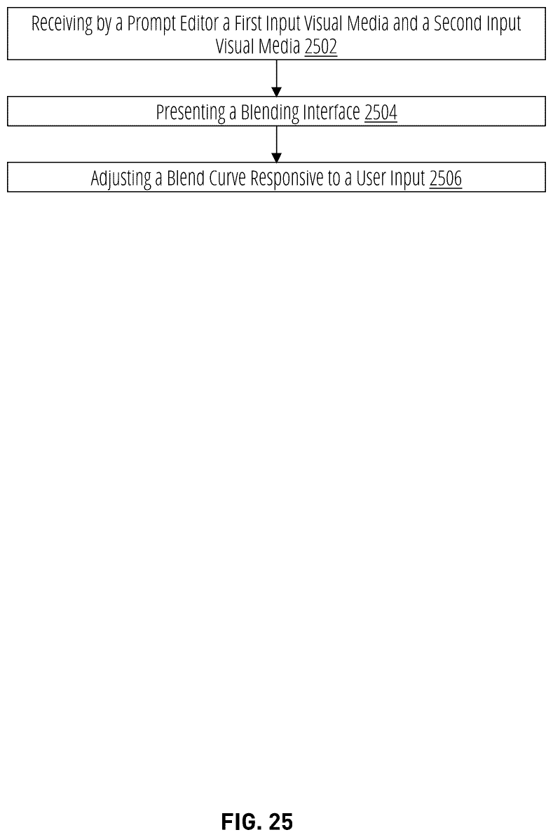

FIG. 25 illustrates an example process for influencing a blending of a first visual media with a second visual media in accordance with some embodiments of the present technology. Although the example process depicts a particular sequence of operations, the sequence may be altered without departing from the scope of the present disclosure. For example, some of the operations depicted may be performed in parallel or in a different sequence that does not materially affect the function of the process. In other examples, different components of an example device or system that implements the process may perform functions at substantially the same time or in a specific sequence.

According to some examples, the method includes receiving by a prompt editor a first input visual media and a second input visual media at block 2502. For example, the front end 124 illustrated in FIG. 1 may receive by a prompt editor a first input visual media and a second input visual media.

According to some examples, the method includes presenting a blending interface at block 2504. For example, the front end 124 illustrated in FIG. 1 may present a blending interface. The blending interface displays at least one frame of the first input visual media and at least one frame of the second input visual media. FIG. 26A illustrates an example of blending interface 2600 with first input visual media 2602 and second input visual media 2604.

According to some examples, the method includes adjusting the blend curve responsive to a user input at block 2506. For example, the front end 124 illustrated in FIG. 1 may be used to adjust a blend curve responsive to user input. The blend curve is representative of an influence of the first input visual media relative to the second input visual media over time.

In some embodiments, the user input is a selection of a pre-configured blend curve. For example, FIG. 26B shows pre-configured blend curves, including transition, mix, and sample. The transition blend curve is used to transition from complete influence by the first input visual media 2602 to complete influence by second input visual media 2604, and in the middle of the visual media, the frames reflect a transition from the first input visual media 2602 to the second input visual media 2604. The mix blend curve is used to mix aspects of the first input visual media 2602 and the second input visual media 2604. The sample blend curve is used to adjust the amount of influence the first input visual media 2602 when being combined with the second input visual media 2604.

In some embodiments, the user can also interact with the user interface to select and create a custom blend curve.

The blend curve selected in the user interface can be translated into an input into the visual media generative response engine by combining aspects of a frame of the first visual media and the second visual media into a blended frame. For example, a frame of the first visual media in an encoded representation can be blended with a frame of the second visual media in an encoded representation through a mathematical operation by applying a weighting factor to the respective frames that correspond to the selected blend curve. The combined encoded representation of the frame can be introduced to the visual media generative response engine. This process can be repeated for several or even all of the frames of the visual media to guide the transition of the visual media from starting with the first visual media and ending with the second visual media.

Another mechanism to combine the two frames can be to create CLIP embeddings from the respective frames and mathematically combine those embeddings in a mathematical operation that is similar to the mathematical operation for the encoded representations addressed above. This process can be repeated for several or even all of the frames of the visual media to guide the transition of the visual media from starting with the first visual media and ending with the second visual media.

Another mechanism to combine the two frames can be to add a text prompts instructing the visual media generative response engine to generate a combined frame using a degree of influence from a frame of a first visual media relative to a degree of influence from a frame of the second visual media. These text prompts can be supplied throughout the length of the visual media and varied to match the amount of blending for that frame of the visual media.

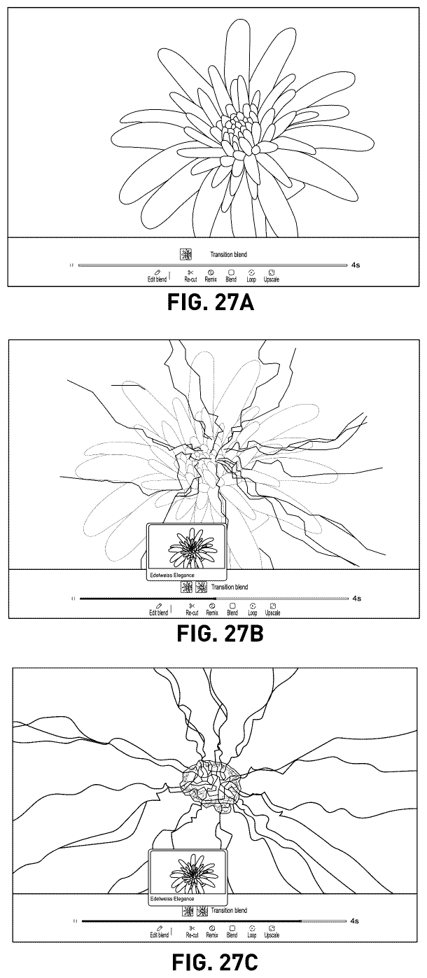

FIG. 27A, FIG. 27B, and FIG. 27C illustrates frames of a blended visual media using a transition blend curve in accordance with some embodiments of the present technology. The prompt for the visual media illustrated across FIG. 27A, FIG. 27B, and FIG. 27C utilized a first input visual media and a second input visual media, along with a text prompt that describes the desired effect described by the transition blend curve.

FIG. 27A illustrates a first frame of a visual media generated by the visual media generative response engine. The first frame is the same as the first input visual media. FIG. 27B illustrates a transition frame that blends aspects of the first input visual media and the second input visual media. The visual media ends with the last frame illustrated in FIG. 27C, which is the same as the second input visual media.

FIG. 28 illustrates a loop interface in accordance with some embodiments of the present technology. Loop interface 2800 can be used to edit frames at the start and end of a video to allow for the seamless looping of a video. As illustrated in FIG. 28 a user has cropped frames from the start and end of the video so that it will display in a seamless loop when the video loops. While this interface looks like it is a simple cropping interface, the cropping in this interface is an input to the visual media generative response engine which receives the input frames and outputs additional frames to result in an output visual media that ends with the exact frame that should precede the first frame of the visual media.

While the present technology provides loop interface 2800, it is possible to generate video that is ready to be looped. A user could use a storyboard user interface and insert the same frame to be the first and last frame of the visual media, or the user could use this loop interface 2800 to provide a prompt that specifies the generated visual media should end with a frame that can seamlessly loop back to the first frame. Both techniques can result in a video ready to be looped without careful selection of frames in loop interface 2800.

FIG. 29 illustrates a trim frames interface button in accordance with some embodiments of the present technology. Trim frames interface 2900 can be used to trim frames off the front and/or back of a generated video by manipulating the sliders in the interface to include frames that should remain as part of the video. Alternatively, the interface could be used to identify frames to be removed.

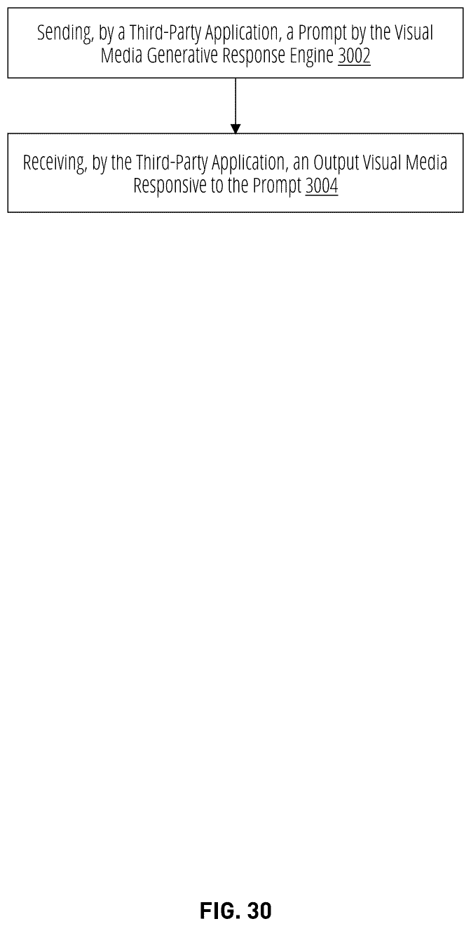

FIG. 30 illustrates an example process for requesting visual media from a visual media generative response engine using an API in accordance with some embodiments of the present technology. Although the example process depicts a particular sequence of operations, the sequence may be altered without departing from the scope of the present disclosure. For example, some of the operations depicted may be performed in parallel or in a different sequence that does not materially affect the function of the process. In other examples, different components of an example device or system that implements the process may perform functions at substantially the same time or in a specific sequence.

While most of the present description has referred to front end 124 providing a graphical user interface to guide a user to create a prompt, the present technology also supports other applications (whether first-party, second-party, or third-party applications) that might handle the user input and display of the output by offering an application programming interface (API) that the other applications can call to request output from the visual media generative response engine. As shown in FIG. 8 front end 802 can also provide functionality to receive API calls.

According to some examples, the method includes sending, by an application, a prompt to the visual media generative response engine at block 3002. The prompt is provided to the visual media generative response engine using an application programming interface (API) provided by the visual media generative response engine. The API can define a text prompt field for providing text values descriptive of visual media to be generated by the visual media generative response engine. In some embodiments, the text prompt field defines a sub-field for the text values and an associated sub-field for a timestamp to be associated with the text value. The text prompt field can have multiple text prompts and associated time stamps. The API can also define a visual media prompt field that further defines a sub-field from the visual media prompt and a sub-field for an associated timestamp. The visual media prompt field can also accommodate multiple visual media prompts. The visual media can be provided in the API by providing links to the visual media that the visual media generative response engine can download or by transmitting the visual media in an archive that matches the visual media prompt and timestamp to the correct file.

The API defines fields to specify a duration, a resolution, and an aspect ratio for the output visual media.

Through the combination of the prompts and their corresponding timestamps prompts such as those created by the storyboard user interface addressed above can be accommodated via the API.

According to some examples, the method includes receiving, by the third-party application, an output visual media responsive to the prompt at block 3004.

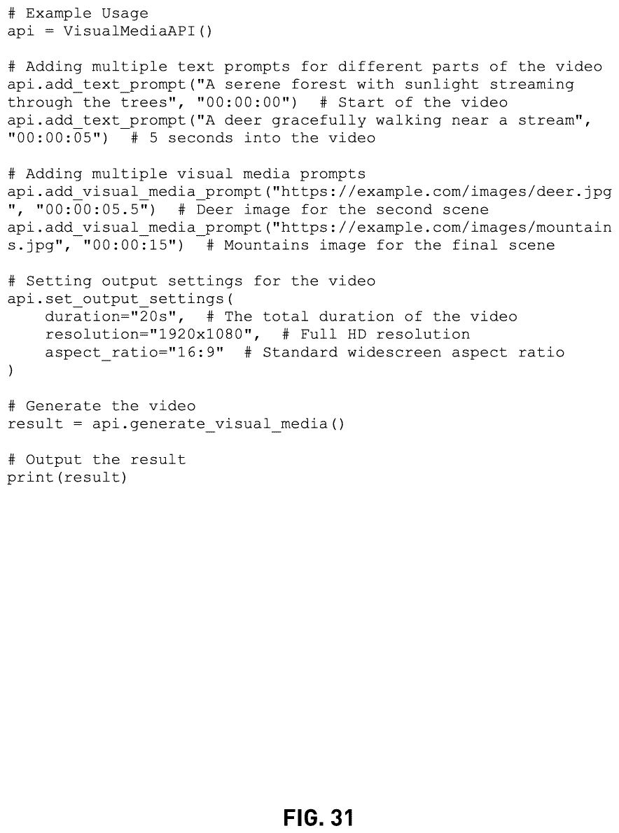

FIG. 31 illustrates an example of an API call in accordance with some embodiments of the present technology. For example, the API call in FIG. 31 includes a prompt that is descriptive of the overall visual media at 0 seconds-“A serene forest with sunlight streaming through the trees.” The API call also includes a text prompt at 5 seconds-“A deer gracefully walking near a stream” and a corresponding visual media prompt at 5.5 seconds, which includes an image of a deer. The API call also includes an additional visual media prompt that, at 15 seconds, shows an image of a mountain.

Finally, the API call also includes settings for the output media. The API requests a video of 20 seconds in duration, a resolution of 1920×1080, and an aspect ratio of 16:9.

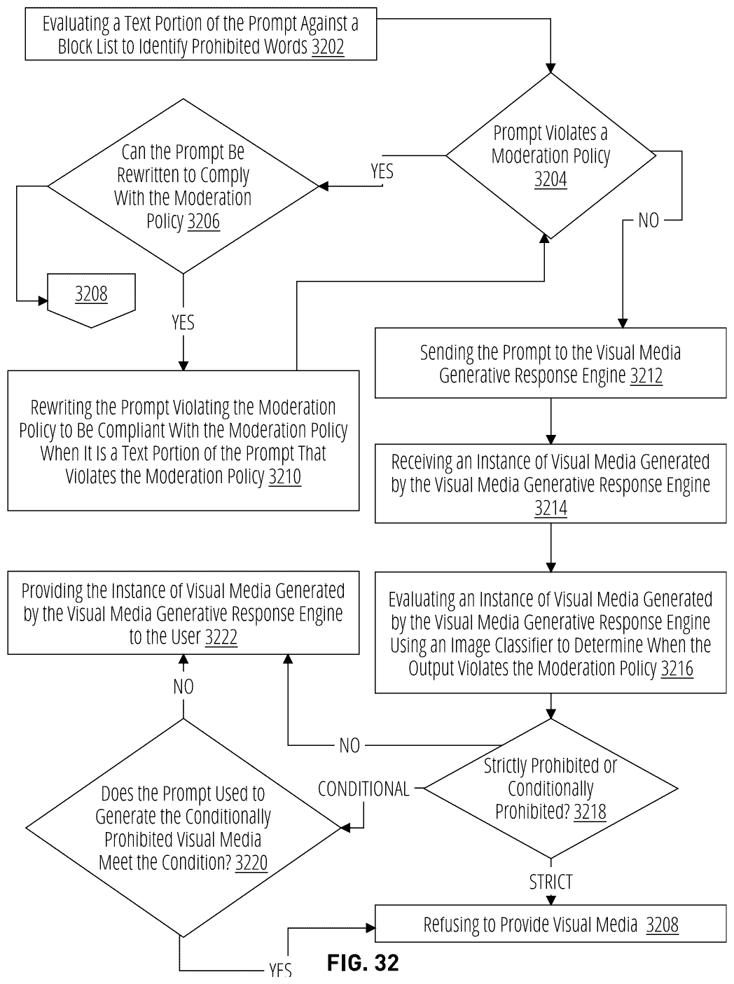

FIG. 32 illustrates an example process for moderating visual media generated by the visual media generative response engine in accordance with some embodiments of the present technology. Although the example process depicts a particular sequence of operations, the sequence may be altered without departing from the scope of the present disclosure. For example, some of the operations depicted may be performed in parallel or in a different sequence that does not materially affect the function of the process. In other examples, different components of an example device or system that implements the process may perform functions at substantially the same time or in a specific sequence.

While the visual media generative response engine is a powerful tool that can aid visual artists in creating high-quality visual art more easily than with prior technologies, some safety mechanisms are needed. Previous image generators have been used to create deepfakes and graphics to spread disinformation, among other undesirable use cases. Therefore, the present technology utilizes several moderation mechanisms to prevent harmful or undesirable content from being generated by the visual media generative response engine.

While the description of a moderation policy is provided herein, it should be apparent to the person of ordinary skill in the art that some content moderation reflects judgments that can evolve over time. No example should be considered as a statement of the inventors' or Applicant's policy regarding certain moderations. All discussions are for purposes of addressing the present technology and providing explanatory examples, and should not be considered limiting of the present technology unless explicitly recited in the claims.

The method begins when a prompt is passed to moderation system 838.

In some embodiments, some words or combinations of words are clearly intended to generate content that a moderation policy is configured to prohibit. In such instances, text matching can be used as a first, quick line of defense against such prompts. According to some examples, the method includes evaluating a text portion of the prompt against a block list to identify prohibited words at block 3202. For example, the moderation system 838 illustrated in FIG. 8 may evaluate a text portion of the prompt against a block list to identify prohibited words or combinations of words. When a prompt includes words in a block list, it may be possible to rewrite the prompt in a way that does not use the words in the block list, and in such cases, the prompt can be passed to decision block 3206, addressed further below.

When the prompt does not include words in a block list, the prompt might still result in content for which it is desired to moderate. In some cases, the user might not intend to craft a prompt that will result in moderated content. To combat the possibility that a prompt might result in content that should be moderated under the moderation policy, the present technology can utilize a more sophisticated method to evaluate the entire prompt. According to some examples, the method includes evaluating a prompt to classify a prompt as violating a moderation policy at decision block 3204. For example, the moderation system 838 illustrated in FIG. 8 may evaluate a prompt to classify a prompt as violating a moderation policy.

One consequence of the fact that users of the visual media generative response engine expect some amount of delay while the visual media is generated is that the visual media generative response engine can utilize more sophisticated tools to evaluate prompts and generated content. The time it takes such tools to evaluate prompts and generated content is relatively small compared to the time it takes to generate the visual media. As such, the present technology is not limited to techniques that might be too simple to be robust and can utilize more sophisticated evaluation techniques and models.

For example, the moderation system could utilize embedding spaces to attempt to classify prompts as being likely to result in content that is moderated by the moderation policy. In another example, the moderation system includes a language model that is configured to identify prompts that request the visual media generative response engine to output visual media that would violate the moderation policy.

In some embodiments, the moderation system can utilize a number of different models, instances of the same model, or in the case of a language model, could utilize a language model program that would guide the language model through a plurality of prompts and responses designed to evaluate the prompts in a more deliberate manner. For example, the language model could be a plurality of instances of the language model respectively configured to identify when the text prompt would violate a particular aspect of the moderation policy. In fact, it can be desirable to have specific instances of a model (or specific prompts to the same model) for respective aspects of the moderation policy. In contrast to training a machine learning model to detect all prompts that might violate the moderation policy, it can provide greater control to have smaller models or individual prompts for different aspects of the moderation policy. This way, if a change needs to be made to a specific part of the moderation policy, a whole new model does not need to be trained. Instead, only a smaller model or prompts pertaining to the specific part of the moderation policy need to be adjusted.

In some embodiments, the moderation system can be multi-modal, meaning it can evaluate portions of the prompt that are given in text, visual media, speech, etc. For example, the language model for evaluating the prompt can be a multi-modal language model, whereby it can evaluate an image portion of the prompt and a text portion of the prompt.

According to some examples, the method includes determining whether the prompt should be rewritten to comply with the moderation policy at decision block 3206. For example, the moderation system 838 illustrated in FIG. 8 determines whether the prompt can be rewritten to comply with the moderation policy. In some embodiments, when it is determined that a visual media portion of the prompt violates the moderation policy, the prompt is rejected and not revised. In some embodiments, it can be determined that the text portion of the prompt violates a particular aspect of the moderation policy and cannot be rewritten. When the prompt cannot be revised the method proceeds to block 3208, addressed below.

According to some examples, the method includes rewriting the prompt violating the moderation policy to be compliant with the moderation policy at block 3210. For example, the moderation system 838 illustrated in FIG. 8 may rewrite the prompt violating the moderation policy to be compliant with the moderation policy when it is the text portion of the prompt that violates the moderation policy.

An example of a prompt that can be written might be a prompt that asks to draw a picture of “a cartoon mouse like Mickey Mouse riding a train.” In this case, the prompt could be rewritten to draw a picture of “a cartoon mouse with large ears and a cheerful expression, riding a vintage steam train.” This prompt can be rewritten because the overall intent is unobjectionable as long as the output does not include Mikey Mouse. An example of a prompt that cannot be rewritten is a prompt that might be requesting visual media depicting self-harm. This prompt can't be rewritten because the intent is to produce visual media that will not comply with the moderation policy.

According to some examples, the method includes sending the prompt to the visual media generative response engine at block 3212. For example, the moderation system 838 illustrated in FIG. 8 may send the prompt to the visual media generative response engine when the prompt is compliant with the moderation policy.

According to some examples, the method includes receiving an instance of visual media generated by the visual media generative response engine at block 3214.

It is not only the prompts that should be evaluated against a content moderation policy. Sometimes, even compliant prompts with good intent behind them can result in generated visual media that would be objectionable. According to some examples, the method includes evaluating an instance of visual media generated by the visual media generative response engine using an image classifier to determine when the output violates the moderation policy at block 3216. For example, the moderation system 838 illustrated in FIG. 8 may evaluate an instance of visual media generated by the visual media generative response engine using an image classifier to determine when the output violates the moderation policy.

When the generated visual media triggers an image classifier at block 3216, the method includes determining whether the image classifier is associated with a moderation policy for strictly prohibited content or conditionally prohibited content at decision block 3218. For example, the moderation system 838 illustrated in FIG. 8 may determine whether the image classifier is associated with a moderation policy for strictly prohibited content or conditionally prohibited content.

One example of content that might be conditionally prohibited is content that depicts a person in a potentially objectionable circumstance or way. If the person were fabricated by the visual media generative response engine, the content might be acceptable. But if the person were present in an input visual media as part of the prompt, the content might tend towards a deepfake type of content and would be objectionable. Therefore, according to some examples, the method includes determining whether the prompt used to generate the instance of conditionally prohibited visual media was a text prompt at decision block 3220. For example, the moderation system 838 illustrated in FIG. 8 may determine that the prompt used to generate the instance of visual media was a text prompt. If the prompt was a text prompt, the conditionally objectionable visual media can be allowed, and the method can progress to block 3222.

According to some examples, the method includes providing the instance of visual media generated by the visual media generative response engine to the user at block 3222. For example, the moderation system 838 illustrated in FIG. 8 may provide the instance of visual media generated by the visual media generative response engine to the user when the output is not prevented by the moderation policy.

If it is determined that the prompt used to generate the conditionally objectionable content was a visual prompt, the moderation system will not output the instance of visual media generated by the visual media generative response engine at block 3208. Also, if the output is strictly prohibited, the visual media cannot be provided to the user.

According to some examples, the method includes refusing to provide visual media from the visual media generative response engine when the prompt or the output violates the moderation policy at block 3208. For example, the moderation system 838 illustrated in FIG. 8 may refuse to provide visual media from the visual media generative response engine when the prompt or the output violates the moderation policy.

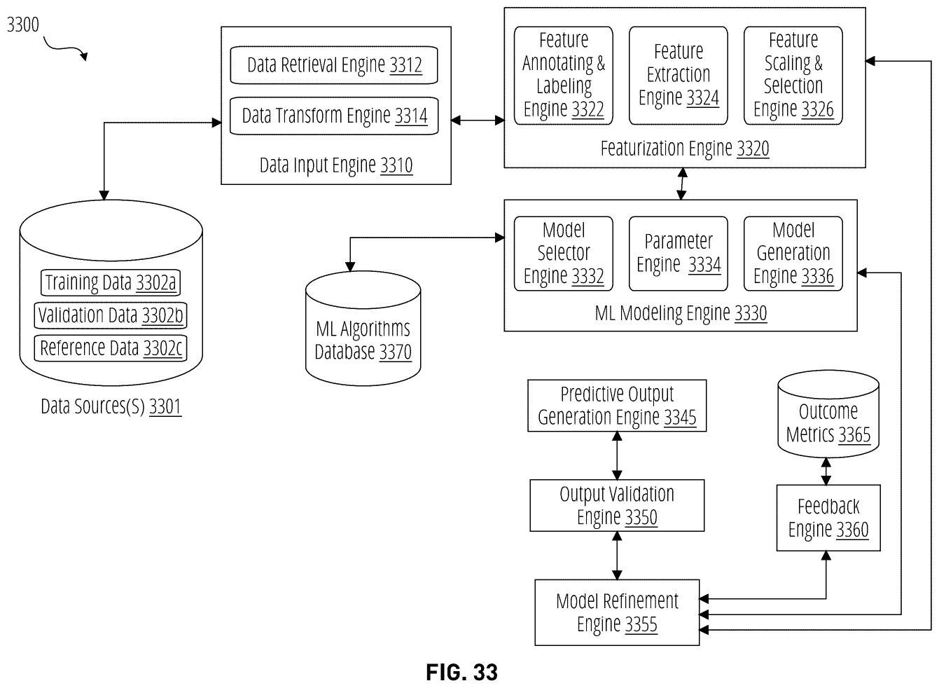

FIG. 33 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 3300 may include data input engine 3310 that can further include data retrieval engine 3312 and data transform engine 3314. Data retrieval engine 3312 may be configured to access, interpret, request, or receive data, which may be adjusted, reformatted, or changed (e.g., to be interpretable by another engine, such as data input engine 3310). For example, data retrieval engine 3312 may request data from a remote source using an API. Data input engine 3310 may be configured to access, interpret, request, format, re-format, or receive input data from data sources(s) 3301. For example, data input engine 3310 may be configured to use data transform engine 3314 to execute a re-configuration or other change to data, such as a data dimension reduction. In some embodiments, data sources(s) 3301 may be associated with a single entity (e.g., organization) or with multiple entities. Data sources(s) 3301 may include one or more of training data 3302a (e.g., input data to feed a machine learning model as part of one or more training processes), validation data 3302b (e.g., data against which at least one processor may compare model output with, such as to determine model output quality), and/or reference data 3302c. In some embodiments, data input engine 3310 can be implemented using at least one computing device. For example, data from data sources(s) 3301 can be obtained through one or more I/O devices and/or network interfaces. Further, the data may be stored (e.g., during execution of one or more operations) in a suitable storage or system memory. Data input engine 3310 may also be configured to interact with a data storage, which may be implemented on a computing device that stores data in storage or system memory.

System 3300 may include featurization engine 3320. Featurization engine 3320 may include feature annotating & labeling engine 3322 (e.g., configured to annotate or label features from a model or data, which may be extracted by feature extraction engine 3324), feature extraction engine 3324 (e.g., configured to extract one or more features from a model or data), and/or feature scaling & selection engine 3326 Feature scaling & selection engine 3326 may be configured to determine, select, limit, constrain, concatenate, or define features (e.g., AI features) for use with AI models.

System 3300 may also include machine learning (ML) ML modeling engine 3330, which may be configured to execute one or more operations on a machine learning model (e.g., model training, model re-configuration, model validation, model testing), such as those described in the processes described herein. For example, ML modeling engine 3330 may execute an operation to train a machine learning model, such as adding, removing, or modifying a model parameter. Training of a machine learning model may be supervised, semi-supervised, or unsupervised. In some embodiments, training of a machine learning model may include multiple epochs, or passes of data (e.g., training data 3302a) through a machine learning model process (e.g., a training process). In some embodiments, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed embodiments in any way, a machine learning model may include millions, billions, or even trillions of model parameters. ML modeling engine 3330 may include model selector engine 3332 (e.g., configured to select a model from among a plurality of models, such as based on input data), parameter engine 3334 (e.g., configured to add, remove, and/or change one or more parameters of a model), and/or model generation engine 3336 (e.g., configured to generate one or more machine learning models, such as according to model input data, model output data, comparison data, and/or validation data).

In some embodiments, model selector engine 3332 may be configured to receive input and/or transmit output to ML algorithms database 3370. Similarly, featurization engine 3320 can utilize storage or system memory for storing data and can utilize one or more I/O devices or network interfaces for transmitting or receiving data. ML algorithms database 3370 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a diffusion model, a diffusion-transformer model, an encoder such as BERT (Bidirectional Encoder Representations from Transformers) or LXMERT (Learning Cross-Modality Encoder Representations from Transformers), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Some of the ML algorithms in ML algorithms database 3370 can be considered generative response engines. Generative response engines are those models are commonly referred to as Generative AI, and that can receive an input prompt and generate additional content based on the prompt. GPTs, diffusion models, and diffusion-transformer models are some non-limiting examples of generative response engines. Some specific examples of generative response engines that can be stored in the ML algorithms database 3370 include versions DALL·E, CHAT GPT, and SORA, all provided by OPEN AI.

System 3300 can further include predictive output generation engine 3345 and output validation engine 3350 (e.g., configured to apply validation data to machine learning model output). Predictive output generation engine 3345 can analyze the input and identify relevant patterns and associations in the data it has learned to generate a sequence of words that predictive output generation engine 3345 predicts is the most likely continuation of the input using one or more models from the ML algorithms database 3370, aiming to provide a coherent and contextually relevant answer. Predictive output generation engine 3345 generates responses by sampling from the probability distribution of possible words and sequences, guided by the patterns observed during its training. In some embodiments, predictive output generation engine 3345 can generate multiple possible responses before presenting the final one. Predictive output generation engine 3345 can generate multiple responses based on the input, and these responses are variations that predictive output generation engine 3345 considers potentially relevant and coherent. Output validation engine 3350 can evaluate these generated responses based on certain criteria. These criteria can include relevance to the prompt, coherence, fluency, and sometimes adherence to specific guidelines or rules, depending on the application. Based on this evaluation, output validation engine 3350 selects the most appropriate response. This selection is typically the one that scores highest on the set criteria, balancing factors like relevance, informativeness, and coherence.

System 3300 can further include feedback engine 3360 (e.g., configured to apply feedback from a user and/or machine to a model) and model refinement engine 3355 (e.g., configured to update or re-configure a model). In some embodiments, feedback engine 3360 may receive input and/or transmit output (e.g., output from a trained, partially trained, or untrained model) to outcome metrics database 3365. Outcome metrics database 3365 may be configured to store output from one or more models and may also be configured to associate output with one or more models. In some embodiments, outcome metrics database 3365, or other device (e.g., model refinement engine 3355 or feedback engine 3360), may be configured to correlate output, detect trends in output data, and/or infer a change to input or model parameters to cause a particular model output or type of model output. In some embodiments, model refinement engine 3355 may receive output from predictive output generation engine 3345 or output validation engine 3350. In some embodiments, model refinement engine 3355 may transmit the received output to featurization engine 3320 or ML modeling engine 3330 in one or more iterative cycles.

The engines of system 3300 may be packaged functional hardware units designed for use with other components or a part of a program that performs a particular function (e.g., of related functions). Any or each of these modules may be implemented using a computing device. In some embodiments, the functionality of system 3300 may be split across multiple computing devices to allow for distributed processing of the data, which may improve output speed and reduce computational load on individual devices. In some embodiments, system 3300 may use load-balancing to maintain stable resource load (e.g., processing load, memory load, or bandwidth load) across multiple computing devices and to reduce the risk of a computing device or connection becoming overloaded. In these or other embodiments, the different components may communicate over one or more I/O devices and/or network interfaces.

System 3300 can be related to different domains or fields of use. Descriptions of embodiments related to specific domains, such as natural language processing or language modeling, is not intended to limit the disclosed embodiments to those specific domains, and embodiments consistent with the present disclosure can apply to any domain that utilizes predictive modeling based on available data.

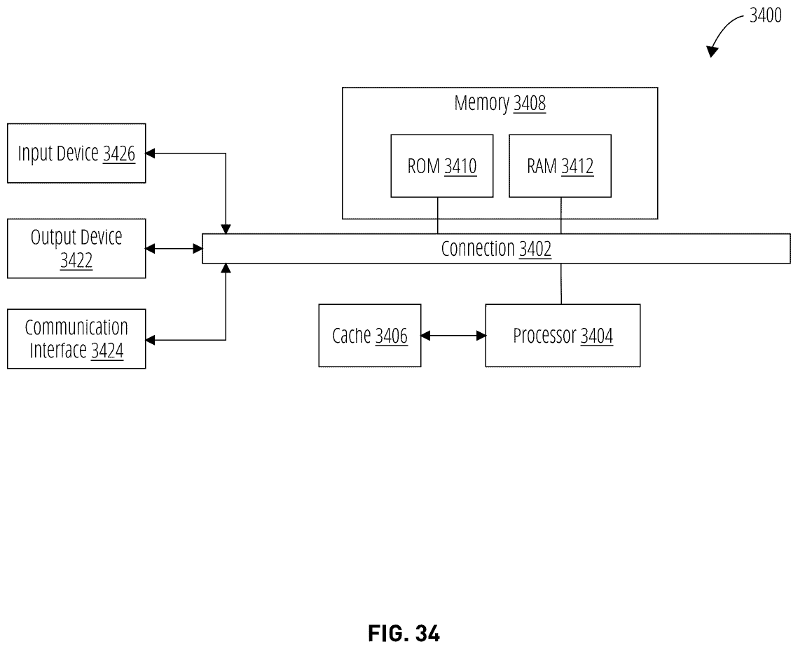

FIG. 34 shows an example of computing system 3400, which can be, For example, any computing device making up any engine illustrated in FIG. 1, FIG. 8, and/or FIG. 33 or any component thereof.

In some embodiments, computing system 3400 is a single device, or a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

In some embodiments, computing system 3400 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 3400 includes at least one processing unit (CPU or processor) 3404 and connection 3402 that couples various system components including system memory 3408, such as read-only memory (ROM) 3410 and random access memory (RAM) 3412 to processor 3404. Memory 3408 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 3408 can include software services, servers, logic, etc., that when the code that defines such software is executed by the processor 3404, it causes the system to perform a function. In some embodiments, a hardware service that performs a particular function can include the software component stored in a computer-readable medium in connection with the necessary hardware components, such as processor 3404, connection 3402, output device 3422, etc., to carry out the function.

Computing system 3400 can include a cache of high-speed memory 3406 connected directly with, in close proximity to, or integrated as part of processor 3404.

Connection 3402 can be a physical connection via a bus, or a direct connection into processor 3404, such as in a chipset architecture. Connection 3402 can also be a virtual connection, networked connection, or logical connection.

Processor 3404 can include any general purpose processor and a hardware service or software service stored in memory 3408, configured to control processor 3404 as well as a special-purpose processor where software instructions are incorporated into the actual processor design. Processor 3404 may essentially be a completely self-contained computing system, containing multiple cores or processors, a bus, memory controller, cache, etc. A multi-core processor may be symmetric or asymmetric. Processor 3404 can be physical or virtual.

To enable user interaction, computing system 3400 includes an input device 3426, which can represent any number of input mechanisms, such as a microphone for speech, a touch-sensitive screen for gesture or graphical input, keyboard, mouse, motion input, speech, etc. Computing system 3400 can also include output device 3422, which can be one or more of a number of output mechanisms known to those of skill in the art. In some instances, multimodal systems can enable a user to provide multiple types of input/output to communicate with computing system 3400. Computing system 3400 can include communication interface 3424, which can generally govern and manage the user input and system output. There is no restriction on operating on any particular hardware arrangement, and therefore the basic features here may easily be substituted for improved hardware or firmware arrangements as they are developed.

In some embodiments, computing system 3400 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or process in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### ASPECTS

The present technology includes computer-readable storage mediums for storing instructions, and systems for executing any one of the methods embodied in the instructions addressed in the aspects of the present technology presented below:
Aspect 1: A visual media generative response engine comprising: an input layer that is configured to receive a prompt, wherein the prompt can include prompt text and/or a prompt frame, the input layer further configured to output at least one noisy frame; a visual encoder layer that is configured to compress the at least one noisy frame, and when the prompt includes the prompt frame the visual encoder layer is configured to also compress the prompt frame, into respective representations in lower-dimensional latent space, wherein the visual encoder layer is a learned compression model that reduces dimensionality of visual data, the visual encoder layer is configured to take raw visual media as input and output a latent representation that is compressed both temporally as well as spatially; a vector representation layer, wherein the vector representation layer is configured to decompose the latent representation into spacetime patches that represent at least one frame, wherein the spacetime patches acts as transformer tokens; an embedding layer that is configured to create a prompt embedding; a diffusion-transformer layer that is configured to process the spacetime patches in accordance with the prompt embedding to iteratively remove noise from the spacetime patches to yield processed spacetime patches, wherein the diffusion-transformer layer includes diffusion-transformer processing units that respectively process respective spacetime patches in parallel, the diffusion-transformer processing units have an associated attention head configured to communicate with attention heads of other diffusion-transformer processing units to perform a self-attention operation that informs respective diffusion-transformer processing units of information pertaining to other spacetime patches being processed by the other diffusion-transformer processing units; a linearization layer that is configured to linearize the processed spacetime patches from the respective diffusion-transformer processing units into an output sequence of encoded spacetime patches; and a patch decoder layer that is configured to decode the output sequence of encoded spacetime patches into pixel space to result in an output video.
Aspect 2: The visual media generative response engine of aspect 1, wherein the diffusion-transformer processing units are graphical processing units.
Aspect 3: The visual media generative response engine of any one of aspects 1-2, wherein the visual media generative response engine is trained on videos and images of disparate durations, resolutions, aspect ratios.
Aspect 4: The visual media generative response engine of any one of aspects 1-3, wherein the visual media generative response engine is trained on videos and images in their native resolution and aspect ratio.
Aspect 5: The visual media generative response engine of any one of aspects 1-4, wherein the visual media generative response engine can output video of different durations, aspect ratios, and resolutions
Aspect 6: The visual media generative response engine of any one of aspects 1-5, wherein the spacetime patches constitutes a single frame when the prompt requests an image as an output.
Aspect 7: The visual media generative response engine of any one of aspects 1-6, wherein the visual media generative response engine was trained by providing an input noisy patches of at least one frame and a training prompt describing an image, and rewarding the diffusion-transformer layer for accurate predictions of original patches, wherein the training prompt is the visual media, when the training prompt is the text prompt, the text prompt is a detailed description of the original patches, wherein the text prompt is automatically generated from an image-to-text captioner model that is trained to create the detailed description of the original patches from the original patches and/or a short prompt describing the original patches; and the patch decoder layer that maps generated patches in latent representations to pixel space.
Aspect 8: The visual media generative response engine of any one of aspects 1-7, wherein the visual media generative response engine is trained by providing Contrastive Language-Image Pretraining (CLIP) embeddings to the diffusion-transformer layer interleaved within the spacetime patches making up the frames of the videos.
Aspect 9: A method of generating visual media of disparate durations, resolutions, aspect ratios using a visual media generative response engine, the method comprising: receiving, by an input layer of the visual media generative response engine, an input prompt by the visual media generative response engine, wherein the input prompt is text, the input prompt can also include duration, resolution, and/or aspect ratio specifications; outputting, by the visual media generative response engine, a video responsive to the input prompt, wherein the video matches the duration, resolution, and/or aspect ratio specifications.
Aspect 10: The method of aspect 9, wherein the input prompt includes visual media and the text.
Aspect 11: The method of any one of aspects 9-10, further comprising: providing, by the input layer, at least one noisy frame corresponding to the duration, resolution, and/or aspect ratio specifications as an input in addition to the input prompt; compressing, by a visual encoder layer, the at least one noisy frame and at least one frame of any prompt video or image frame into respective representations in lower-dimensional latent space; and decomposing, by a vector representation layer, the respective representations in lower-dimensional latent space into spacetime patches that represent the at least one frame.
Aspect 12: The method of any one of aspects 9-11, wherein the providing the at least one noisy frame includes controlling the resolution and/or the aspect ratio of generated videos by arranging randomly-initialized patches in an appropriately-sized grid to result the at least one noisy frame, wherein the visual media generative response engine is configured to covert the at least one noisy frame into a completed image frame having the same aspect ratio and the resolution as the at least one noisy frame.
Aspect 13: The method of any one of aspects 9-12, further comprising: generating, by an embedding layer, a prompt embedding from the text of the input prompt.
Aspect 14: The method of any one of aspects 9-13, further comprising: generating, by an embedding layer, an Contrastive Language-Image Pretraining (CLIP) embedding from one or more frames of the prompt.
Aspect 15: The method of any one of aspects 9-14, further comprising: processing, by a diffusion-transformer layer, the spacetime patches in accordance with a prompt embedding.
Aspect 16: The method of any one of aspects 9-15, wherein the diffusion-transformer layer includes diffusion-transformer processing units that respectively process respective patches in the spacetime patches in parallel.
Aspect 17: The method of any one of aspects 9-16, further comprising: communicating with attention heads of other diffusion-transformer processing units to perform a self-attention operation that informs respective diffusion-transformer processing units of information pertaining to other spacetime patches being processed by the other diffusion-transformer processing units.
Aspect 18: The method of any one of aspects 9-17, wherein the duration is zero seconds, and the video responsive to the input prompt is a still image.
Aspect 19: The method of any one of aspects 9-18, wherein the input prompt includes an image as the visual media and the text instructs to generate a video from the image, and the video responsive to the input prompt includes the image as part of the video responsive to the input prompt.
Aspect 20: The method of any one of aspects 9-19, wherein the input prompt includes a prompt video as the visual media and the text instructs to generate an extended video in a time-forward or time-backward dimension from the prompt video, and the extended video responsive to the input prompt includes the prompt video with additional frames.
Aspect 21: The method of any one of aspects 9-20, wherein the input prompt includes at least two prompt videos as the visual media and the text instructs to create a blended video that blends from a first of the at least two prompt videos to a second of the at least two prompt videos, and the blended video responsive to the input prompt includes aspects of the at least two prompt videos.
Aspect 22: The method of any one of aspects 9-21, wherein the input prompt includes a prompt video as the visual media and the text instructs to modify an aspect of the prompt video, and the video responsive to the input prompt includes the prompt video modified as instructed by the input prompt.
Aspect 23: A method of training a visual media generative response engine, the method comprising: initially training a diffusion-transformer layer of the visual media generative response engine by providing a training set of visual media, wherein the visual media is of disparate durations, resolutions, and/or aspect ratios, wherein the visual media are maintained in their native durations, resolutions, and/or aspect ratios.
Aspect 24: The method of aspect 23, further comprising: performing reinforcement learning by: providing at least one noisy frame and a training prompt describing an existing visual media in a fine-tuning training set, wherein the training prompt is a text prompt that is a detailed description of the existing visual media; rewarding the diffusion-transformer layer for accurate predictions of frames making up the existing visual media.
Aspect 25: The method of any one of aspects 23-24, wherein the fine-tuning of the visual media generative response engine further comprises: selecting sample frames from visual media in the fine-tuning training set; generating respective embedding frames from the sample frames; providing the respective embedding frames in place of one of the at least one noisy frame, whereby the diffusion-transformer layer of the visual media generative response engine receives a plurality of frames including noisy frames and respective embeddings interleaved with the noisy frames, whereby the diffusion-transformer layer learns to predict noisy frames that are consistent with the respective embeddings.
Aspect 26: The method of any one of aspects 23-25, wherein the respective embedding frames are generated using a Contrastive Language-Image Pretraining (CLIP) technique.
Aspect 27: The method of any one of aspects 23-26, wherein the training prompt is generated from an image-to-text captioner model that is trained to create the detailed description of the existing visual media.
Aspect 28: A method for generating a video that includes at least one frame of an input visual media, the method comprising: receiving, by an input layer, an input prompt including text and the input visual media; providing at least one frame of the input visual media to a diffusion-transformer layer of a visual media generative response engine in the form of an embedding or an encoded frame, and providing an embedding of the text to the diffusion-transformer layer; generating, by a visual media generative response engine, the video that is based on the at least one frame of the input visual media, and additional frames generated by the visual media generative response engine based on the text in the input prompt, wherein the additional frames generated by the visual media generative response engine demonstrate spatial and temporal consistency with the at least one frame of the input visual media.
Aspect 29: The method of aspect 28, further comprising: determining, by the input layer, an intent from the text, wherein the intent is to generate the video where the video starts or ends with a portion of the input visual media, or where the intent is to generate the video based on a feature represented in the input visual media.
Aspect 30: The method of any one of aspects 28-29, wherein the intent is to generate the video where the video starts or ends with a portion of the input visual media, the method further comprises: encoding the at least one frame of the input visual media to be included in video into a latent representation that is compressed both temporally as well as spatially; creating an embedding from the text of the input prompt; providing spacetime patches to the diffusion-transformer layer, where a portion of the spacetime patches are created from the latent representation of the at least one frame of the input visual media to be included in video, and the embedding; and receiving an output sequence of encoded spacetime patches that include the spacetime patches created from the latent representation of the at least one frame of the input visual media to be included in video and additional encoded spacetime patches that correspond to the text from the input prompt, whereby the video is generated that includes video that includes at least one frame from the input visual media and generated frames.
Aspect 31: The method of any one of aspects 28-30, wherein the video that is generated starts from the at least one frame from the input visual media and continues with the generated frames.
Aspect 32: The method of any one of aspects 28-31, wherein the video that is generated ends with the at least one frame from the input visual media and begins with the generated frames.
Aspect 33: The method of any one of aspects 28-32, wherein the intent is to generate the video based on a feature represented in the input visual media, the method further comprises: creating an visual embedding that is descriptive of the at least one frame of the input visual media; creating a text embedding from the text of the input prompt; and providing spacetime patches to the diffusion-transformer layer with at least one of the visual embedding and the text embedding of frames interleaved within the frames represented by the spacetime patches, wherein the embeddings describe the feature represented in the input visual media and the desired video based on the feature represented in the input visual media, and thereby guide the generation of video responsive to the prompt.
Aspect 34: The method of any one of aspects 28-33, wherein the video that is generated includes frames with the feature represented in the input visual media in a newly rendered scene or style.
Aspect 35: The method of any one of aspects 28-34, wherein the input visual media includes the at least one frame of the input visual media and at least second frames of a second input visual media, and wherein the output sequence of encoded spacetime patches include: the spacetime patches created from the latent representation of the at least one frame of the input visual media to be included in video, spacetime patches created from the latent representation of the at least second frames of the second input visual media to be included in video, and additional encoded spacetime patches that correspond to the text from the input prompt, whereby the video is generated that starts with video that includes the at least one frame from the input visual media ends with video that includes the at least one frames of the second input visual media.
Aspect 36: A method of requesting visual media from a visual media generative response engine, the method comprising: sending, by a third-party application, a prompt by the visual media generative response engine, wherein the prompt is provided to the visual media generative response engine using an application programming interface (API) provided by the visual media generative response engine, wherein the API defines a text prompt field for providing text values descriptive of visual media to be generated by the visual media generative response engine; and receiving, by the third-party application, an output visual media responsive to the prompt.
Aspect 37: The method of aspect 36, wherein the text prompt field defines a sub-field for the text values and an associated sub-field for a timestamp to be associated with the text value.
Aspect 38: The method of any one of aspects 36-37, wherein the text prompt field permits multiple text prompts and associated time stamps.
Aspect 39: The method of any one of aspects 36-38, wherein the API defines a visual media prompt field that further defines a sub-field from the visual media prompt and a sub-field for an associated timestamp, the method comprising: sending, by the third-party application, a visual media prompt to be used by the generative response engine in generating output visual media.
Aspect 40: The method of any one of aspects 36-39, wherein the API defines fields to specify a duration, a resolution, and an aspect ratio for the output visual media, the method further comprising: sending, by the third-party application, values for the duration, the resolution, and the aspect ratio for the requested output visual media. receiving, by the third-party application, the generated visual media that is responsive to the values for the duration, the resolution, and the aspect ratio.
Aspect 41: A method of creating new visual media from existing visual media prompts, the method comprising: receiving, by a user interface of a visual media generative response engine, a selection of an existing visual media that was previously generated using the visual media generative response engine, wherein the existing visual media can be presented in a public gallery or a private library; presenting the selected existing visual media in response to the selection via the user interface, wherein the selected existing visual media is presented with an example prompt, wherein the example prompt is the prompt used to create the visual media, wherein the example prompt is a machine generated description of a particular frame of the visual media; receiving, by the user interface, an edit to the example prompt; receiving an instruction, by the user interface, to generate a new visual media based on the edit of the example prompt.
Aspect 42: The method of aspect 41, wherein a required input detail that was not provided by a user interacting with the user interface is copied from the existing visual media.
Aspect 43: The method of any one of aspects 41-42, further comprising: presenting a storyboard user interface pre-populated with text prompts and/or one or more frames that describe the existing visual media.
Aspect 44: The method of any one of aspects 41-43, further comprising: generating the new visual media based on the edit of the example prompt using the visual media generative response engine; presenting the new visual media generated using by the visual media generative response engine.
Aspect 45: A method comprising: presenting a graphical user interface including a prompt editor; receiving at least a text input into the prompt edit, wherein the text input is a prompt that describes a visual media to be generated by a visual media generative response engine; receiving a command to generate a visual media using the at least one text input into the prompt editor; prior to generating the visual media, determining at least one of an aspect ratio or a resolution in which to generate the visual media, wherein the visual media visual media generative response engine is capable of generating visual media in multiple resolutions and/or aspect ratios; receiving the visual media generated based on the prompt, the visual media was generated in the aspect ratio or the resolution that was determined.
Aspect 46: The method of aspect 45, wherein the graphical user interface further includes at least one of an aspect ratio input control or a resolution input control, wherein the determining of the at least one of the aspect ratio or the resolution in which to generate the visual media is determined based on explicit input provided using the aspect ratio input control or the resolution input control.
Aspect 47: The method of any one of aspects 45-46, wherein the at least one of the aspect ratio or the resolution in which to generate the visual media is determined from an inference derived from the text input.
Aspect 48: The method of any one of aspects 45-47, wherein the graphical user interface includes a visual media upload button that enables an input visual media to be included as part of the prompt.
Aspect 49: The method of any one of aspects 45-48, wherein the graphical user interface further includes a duration input control, wherein the duration input control is effective to control a duration of the output visual media.
Aspect 50: The method of any one of aspects 45-49, wherein the graphical user interface further includes a number of generations input control, wherein the number of generations input control is effective to cause the visual media generative response engine to generate more than one output visual media.
Aspect 51: The method of any one of aspects 45-51, wherein the graphical user interface includes a prompt enhancement option, wherein, when selected, the prompt enhancement option is effective to input the prompt to a language model to generate an enhanced prompt and to replace the prompt with the enhanced prompt in the prompt editor.
Aspect 52: A method for aiding a user in generating a prompt to a visual media generative response engine through a storyboard user interface, the method comprising: presenting a storyboard user interface, wherein the storyboard user interface includes a visual media timeline and a representation of a first frame located on the visual media timeline; receiving, by the storyboard user interface, a prompt to be associated with the first frame, wherein the prompt can include text or visual media.
Aspect 53: The method of aspect 52, further comprising: receiving a command to generate an output visual media by the visual media generative response engine, wherein the prompt associated with the first frame is provided to the visual media generative response engine along with a first timestamp indicating that the prompt describes a desired output first frame at the first timestamp; and receiving the output visual media having a frame corresponding to the prompt at the first timestamp.
Aspect 54: The method of any one of aspects 52-53, further comprising: presenting an add frame button in the storyboard user interface, wherein the add frame button is effective to cause a representation of a second frame to be presented on the visual media timeline; and receiving, by the storyboard user interface, a second prompt to be associated with the second frame.
Aspect 55: The method of any one of aspects 52-54, further comprising: receiving a move command by the storyboard user interface; in response to the move command, moving the first frame at a first timestamp to a second timestamp.
Aspect 56: A method for inducing a visual media generative response engine to refactor an existing visual media, the method comprising: presenting a remix strength control menu, wherein the remix strength control menu includes options for remix degrees for refactoring the existing visual media; receiving a selection of a first remix degree from the remix strength control menu; receiving an output visual media that is a refactored version of the existing visual media, wherein the amount of refactoring of the existing visual media was controlled by the first remix degree.
Aspect 57: The method of aspect 56, further comprising: in response to receiving the first remix degree, requesting a narrative from a language model, where a prompt to the language model includes the existing visual media or a text caption of the existing visual media with an instruction to generate the narrative based on the existing visual media but varied to according the first remix degree.
Aspect 58: A method for influencing a blending of a first visual media with a second visual media, the method comprising: receiving by a prompt editor a first input visual media and a second input visual media; presenting a blending interface, wherein the blending interface displays at least one frame of the first input visual media and at least one frame of the second input visual media; responsive to a user input, adjusting a blend curve, wherein the blend curve is representative of an influence of the first input visual media relative to the second input visual media over time.
Aspect 59: The method of aspect 58, wherein the user input is a selection of a pre-configured blend curve, wherein the pre-configured blend curve includes a transition, a mix, or a sample blend curve, wherein the transition results in transition from the first input visual media to the second visual media, the mix merges aspects of the first input media with aspects of the second visual media, and sample influences the first visual media with elements of the second visual media.
Aspect 60: The method of any one of aspects 58-59, wherein the user input is a manipulation of the blend curve to create a custom blend curve.
Aspect 61: A method of moderating visual media generated by the visual media generative response engine, the method comprising: evaluating a prompt by a moderation system to classify a prompt as violating a moderation policy, wherein the moderation system includes a language model that is configured to identify prompts that request the visual media generative response engine to output visual media that would violate the moderation policy; and evaluating an instance of visual media generated by the visual media generative response engine using an image classifier to determine when the output violates the moderation policy; refusing to provide visual media from the visual media generative response engine when the prompt or the output violates the moderation policy.
Aspect 62: The method of aspect 61, wherein the language model that is configured to identify prompts that request the visual media generative response engine to output visual media that would violate the moderation policy is a plurality of instances of the language model respectively configured to identify when the text prompt would violate a particular aspect of the moderation policy.
Aspect 63: The method of any one of aspects 61-62, wherein the evaluation the output further comprises: determining that the image classifier has identified a strictly prohibited content category represented in the instance of visual media generated by the visual media generative response engine, wherein the moderation system does not provide the instance of visual media generated by the visual media generative response engine.
Aspect 64: The method of any one of aspects 61-63, wherein the evaluation the output further comprises: determining that the image classifier has identified a conditionally prohibited content category represented in the output; determining that the prompt used to generate the instance of visual media generated by the visual media generative response engine was a text prompt; and providing the instance of visual media generated by the visual media generative response engine to the user because the conditionally prohibited content is not prohibited when it is generated from the text prompt.
Aspect 65: The method of any one of aspects 61-64, wherein the evaluation the output further comprises: determining that the image classifier has identified a conditionally prohibited content category represented in the output; determining that the prompt used to generate the content was a visual prompt, wherein the moderation system does not provide the instance of visual media generated by the visual media generative response engine because the conditionally prohibited content category is prohibited based on the condition that the instance of visual media generated by the visual media generative response engine was generated based on the visual prompt.
Aspect 66: The method of any one of aspects 61-65, further comprising: prior to evaluating the prompt by the language model, evaluating a text portion of the prompt against a block list to identify prohibited words.
Aspect 67: The method of any one of aspects 61-66, wherein the language model for evaluating the prompt is a multi-modal language model, whereby it can evaluate an image portion of the prompt and a text portion of the prompt.
Aspect 68: The method of any one of aspects 61-67, further comprising: after evaluating the prompt to classify a prompt as violating a moderation policy, rewriting the prompt violating the moderation policy to be compliant with the moderation policy when it is a text portion of the prompt that violates the moderation policy.
Aspect 69: The method of any one of aspects 61-68, further comprising: determining that an image portion of the prompt violates the moderation policy, wherein the prompt is rejected.
Aspect 70: The method of any one of aspects 61-69, further comprising: determining that the text portion of the prompt violates a particular aspect of the moderation policy that cannot be rewritten.

What is claimed is:

1. A method comprising:
presenting a graphical user interface including a prompt editor;
receiving at least a text input into the prompt editor as part of an input prompt, wherein the text input is a prompt that describes a visual media to be generated by a visual media generative response engine;
receiving a command to generate the visual media the text input received by the prompt editor;
prior to generating the visual media, determining at least one of a duration, resolution, or aspect ratio in which to generate the visual media, wherein the visual media generative response engine is capable of generating the visual media in multiple durations, resolutions, and aspect ratios;
receiving the visual media generated based on the prompt, the visual media was generated in the duration, the resolution, or the aspect ratio that was determined.

2. The method of claim 1, wherein the input prompt includes visual media and the text input.

3. The method of claim 1, further comprising:
providing at least one noisy frame corresponding to the duration, the resolution, or the aspect ratio to a diffusion-transformer layer to converted in to the visual media.

4. The method of claim 2, wherein the input prompt includes an image as the visual media and the text input instructs to generate a video from the image, and the video responsive to the input prompt includes the image as part of the video responsive to the input prompt.

5. The method of claim 2, wherein the input prompt includes a prompt video as the visual media and the text input instructs to generate an extended video in a time-forward or time-backward dimension from the prompt video, and the extended video responsive to the input prompt includes the prompt video with additional frames.

6. The method of claim 2, wherein the input prompt includes at least two prompt videos as the visual media and the text input instructs to create a blended video that blends from a first of the at least two prompt videos to a second of the at least two prompt videos, and the blended video responsive to the input prompt includes aspects of the at least two prompt videos.

7. The method of claim 2, wherein the input prompt includes a prompt video as the visual media and the text input instructs to modify an aspect of the prompt video, and the video responsive to the input prompt includes the prompt video modified as instructed by the input prompt.

8. The method of claim 2, wherein the graphical user interface further includes at least one of an aspect ratio input control or a resolution input control, wherein the determining of the at least one of the aspect ratio or the resolution in which to generate the visual media is determined based on explicit input provided using the aspect ratio input control or the resolution input control.

9. The method of claim 2, wherein the at least one of the aspect ratio or the resolution in which to generate the visual media is determined from an inference derived from the text input.

10. The method of claim 2, wherein the graphical user interface includes a visual media upload button that enables an input visual media to be included as part of the prompt.

11. The method of claim 2, wherein the graphical user interface further includes a duration input control, wherein the duration input control is effective to control a duration of the generated visual media.

12. The method of claim 2, wherein the graphical user interface further includes a number of generations input control, wherein the number of generations input control is effective to cause the visual media generative response engine to generate more than one visual media.

13. The method of claim 2, wherein the graphical user interface includes a prompt enhancement option, wherein, when selected, the prompt enhancement option is effective to input the prompt to a language model to generate an enhanced prompt and to replace the prompt with the enhanced prompt in the prompt editor.

14. A system comprising:
at least one processor; and
a memory storing instructions that, when executed by the at least one processor, configure the system to:
present a graphical user interface including a prompt editor;
receive at least a text input into the prompt editor as part of an input prompt, wherein the text input is a prompt that describes a visual media to be generated by a visual media generative response engine;
receive a command to generate the visual media the text input received by the prompt editor;
prior to generating the visual media, determine at least one of a duration, resolution, or aspect ratio in which to generate the visual media, wherein the visual media generative response engine is capable of generating the visual media in multiple durations, resolutions, and aspect ratios;
receive the visual media generated based on the prompt, the visual media was generated in the duration, the resolution, or the aspect ratio that was determined.

15. The system of claim 14, wherein the instructions further configure the system to:
provide at least one noisy frame corresponding to the duration, the resolution, or the aspect ratio to a diffusion-transformer layer to converted in to the visual media.

16. The system of claim 14, wherein the input prompt includes visual media and the text input, wherein the input prompt includes an image as the visual media and the text input instructs to generate a video from the image, and the video responsive to the input prompt includes the image as part of the video responsive to the input prompt.

17. The system of claim 14, wherein the input prompt includes visual media and the text input, wherein the input prompt includes a prompt video as the visual media and the text input instructs to modify an aspect of the prompt video, and the video responsive to the input prompt includes the prompt video modified as instructed by the input prompt.

18. A non-transitory computer-readable storage medium comprising instructions that when executed by at least one processor, cause the at least one processor to:
present a graphical user interface including a prompt editor;
receive at least a text input into the prompt editor as part of an input prompt, wherein the text input is a prompt that describes a visual media to be generated by a visual media generative response engine;
receive a command to generate the visual media the text input received by the prompt editor;
prior to generating the visual media, determine at least one of a duration, resolution, or aspect ratio in which to generate the visual media, wherein the visual media generative response engine is capable of generating the visual media in multiple durations, resolutions, and aspect ratios;
receive the visual media generated based on the prompt, the visual media was generated in the duration, the resolution, or the aspect ratio that was determined.

19. The non-transitory computer-readable storage medium of claim 18, wherein the input prompt includes visual media and the text input, wherein the graphical user interface further includes a duration input control, wherein the duration input control is effective to control a duration of the generated visual media.

20. The non-transitory computer-readable storage medium of claim 18, wherein the input prompt includes visual media and the text input, wherein the graphical user interface includes a prompt enhancement option, wherein, when selected, the prompt enhancement option is effective to input the prompt to a language model to generate an enhanced prompt and to replace the prompt with the enhanced prompt in the prompt editor.
